(19) United States
(12) Patent Application Publication
(10) Pub. No.: US 2022/0323917 A1
(43) Pub. Date: Oct. 13, 2022

(54) MANUFACTURING APPARATUS FOR SOLIDIFIED MATTER OF ULTRA-FINE BUBBLE-CONTAINING LIQUID, AND SOLIDIFIED MATTER OF ULTRA-FINE BUBBLE-CONTAINING LIQUID

(71) Applicant: CANON KABUSHIKI KAISHA, Tokyo (JP)

(72) Inventors: Toshio Kashino, Kanagawa (JP); Masahiko Kubota, Tokyo (JP); Akira Yamamoto, Kanagawa (JP); Hiroaki Mihara, Tokyo (JP); Hiroyuki Shimoyama, Hyogo (JP); Ikuo Nakazawa, Kanagawa (JP)

(21) Appl. No.: 17/690,261

(22) Filed: Mar. 9, 2022

(30) Foreign Application Priority Data
Apr. 7, 2021 (JP) 2021-065431

(51) Int. Cl. B01F 23/80; B01F 23/231; F25C 1/18

(52) U.S. Cl. CPC B01F 23/809; B01F 23/811; B01F 23/812; B01F 23/231; B01F 23/805; B01F 23/808; F25C 1/18; B01F 23/703

(57) ABSTRACT

A manufacturing apparatus for a solidified matter of an ultra-fine bubble (UFB)-containing liquid includes: a UFB generating unit that generates the UFB-containing liquid; and a cooling unit that generates the solidified matter of the UFB-containing liquid by cooling the UFB-containing liquid. The cooling unit cools the ultra-fine bubble-containing liquid such that a first solidified portion and a second solidified portion at a lower ultra-fine bubble concentration than that of the first solidified portion are formed in the solidified matter.

### BACKGROUND OF THE INVENTION

### Field of the Invention

The present disclosure relates to a manufacturing apparatus for a solidified matter of a liquid that contains ultra-fine bubbles smaller than 1.0 m in diameter and to the solidified matter.

### Description of the Related Art

Recently, there have been developed techniques for applying the features of fine bubbles such as microbubbles in micrometer-size in diameter and nanobubbles in nanometer-size in diameter. Especially, the utility of ultra-fine bubbles (hereinafter also referred to as “UFBs”) smaller than 1.0 m in diameter has been confirmed in various fields.

As a technique of generating the UFBs, Japanese Patent Laid-Open No. 2019-042664 discloses a technique of manufacturing a UFB-containing liquid that contains UFBs of uniform size by generating a film boiling phenomenon in a liquid by using a heating element substrate. In the manufactured UFB-containing liquid, the UFBs may be released from a gas-liquid interface due to the UFBs put in contact with the atmospheric air, or the purity of the UFBs may be reduced with the atmospheric air (air) dissolved into the liquid. To deal with this, there has also been proposed to freeze the UFB-containing liquid.

Japanese Patent Laid-Open No. 2020-153587 discloses the effectivity of ice that contains ultra-fine bubbles.

Additionally, Japanese Patent Laid-Open No. 2018-132209 discloses a technique of efficiently freezing a liquid that contains ultra-fine bubbles.

### SUMMARY OF THE INVENTION

The present disclosure is a manufacturing apparatus for a solidified matter of an ultra-fine bubble-containing liquid, including: an ultra-fine bubble generating unit that generates an ultra-fine bubble-containing liquid by generating an ultra-fine bubble in a liquid; and a cooling unit that generates a solidified matter of the ultra-fine bubble-containing liquid by cooling the ultra-fine bubble-containing liquid, wherein the cooling unit cools the ultra-fine bubble-containing liquid such that a first solidified portion and a second solidified portion at a lower ultra-fine bubble concentration than that of the first solidified portion are formed in the solidified matter.

Further features of the present invention will become apparent from the following description of exemplary embodiments with reference to the attached drawings.

### BRIEF DESCRIPTION OF THE DRAWINGS

FIG. 1 is a diagram illustrating an example of a UFB generating apparatus;

FIG. 2 is a schematic configuration diagram of a pre-processing unit;

FIGS. 3A and 3B are a schematic configuration diagram of a dissolving unit and a diagram for describing the dissolving states in a liquid;

FIG. 4 is a schematic configuration diagram of a T-UFB generating unit;

FIGS. 5A and 5B are diagrams for describing details of a heating element;

FIGS. 6A and 6B are diagrams for describing the states of film boiling on the heating element;

FIGS. 7A to 7D are diagrams illustrating the states of generation of UFBs caused by expansion of a film boiling bubble;

FIGS. 8A to 8C are diagrams illustrating the states of generation of UFBs caused by shrinkage of the film boiling bubble;

FIGS. 9A to 9C are diagrams illustrating the states of generation of UFBs caused by reheating of the liquid;

FIGS. 10A and 10B are diagrams illustrating the states of generation of UFBs caused by shock waves made by disappearance of the bubble generated by the film boiling;

FIGS. 11A to 11C are diagrams illustrating a configuration example of a post-processing unit;

FIG. 12 is a diagram illustrating a basic conceptual configuration of a manufacturing apparatus for a solidified matter of a UFB-containing liquid;

FIG. 13 is a diagram illustrating a conceptual configuration of a manufacturing apparatus for the solidified matter of the UFB-containing liquid in a first embodiment;

FIG. 14 is a diagram illustrating a detailed configuration of the manufacturing apparatus for the solidified matter of the UFB-containing liquid illustrated in FIG. 13;

FIG. 15A is a plan view illustrating a basic configuration of a UFB generating head;

FIG. 15B is a cross-sectional view of the UFB generating head illustrated in FIG. 15A taken along line XVB-XVB;

FIG. 16A is a plan view illustrating another configuration of the UFB generating head;

FIG. 16B is a cross-sectional view of the UFB generating head illustrated in FIG. 16A taken along line XVIB-XVIB;

FIG. 17A is a perspective view of the UFB generating head illustrated in FIG. 16A;

FIG. 17B is an exploded perspective view of the UFB generating head illustrated in FIG. 16A;

FIG. 18 is a diagram illustrating a conceptual configuration of a manufacturing apparatus for the solidified matter of the UFB-containing liquid in a second embodiment;

FIG. 19 is a diagram illustrating a detailed configuration of the manufacturing apparatus for the solidified matter of the UFB-containing liquid illustrated in FIG. 18;

FIG. 20 is a diagram illustrating a conceptual configuration of a manufacturing apparatus for the solidified matter of the UFB-containing liquid in a third embodiment;

FIG. 21 is a diagram illustrating a detailed configuration of the manufacturing apparatus for the solidified matter of the UFB-containing liquid illustrated in FIG. 20;

FIG. 22 is a diagram illustrating a conceptual configuration of a manufacturing apparatus for the solidified matter of the UFB-containing liquid in a fourth embodiment;

FIG. 23 is a diagram illustrating a detailed configuration of the manufacturing apparatus for the solidified matter of the UFB-containing liquid illustrated in FIG. 22;

FIG. 24 is a diagram illustrating a conceptual configuration of a manufacturing apparatus for the solidified matter of the UFB-containing liquid in a fifth embodiment;

FIG. 25 is a diagram describing a configuration of the manufacturing apparatus for the solidified matter of the UFB-containing liquid illustrated in FIG. 24; and

FIG. 26 is a diagram illustrating a detailed configuration of a manufacturing apparatus for the solidified matter of the UFB-containing liquid in a sixth embodiment.

### DESCRIPTION OF THE EMBODIMENTS

Japanese Patent Laid-Open No. 2020-153587 does not disclose time for freezing the UFB-containing liquid. On the other hand, Japanese Patent Laid-Open No. 2018-132209 discloses a configuration for freezing the UFB-containing liquid in a short time.

However, if the UFB-containing liquid is frozen in a short time in order to promote the efficiency of making ice of the UFB-containing water, there is a risk that the UFBs may disappear and the concentration may be reduced due to the pressure during the freezing of water, and the features of the UFBs may be changed.

The present disclosure provides a technique that allows for manufacturing of a solidified matter of a UFB-containing liquid while keeping the UFBs at an appropriate state.

### [Basic Configuration]

### <UFB Generating Apparatus>

First, a basic configuration of a UFB generating apparatus using the film boiling phenomenon is described.

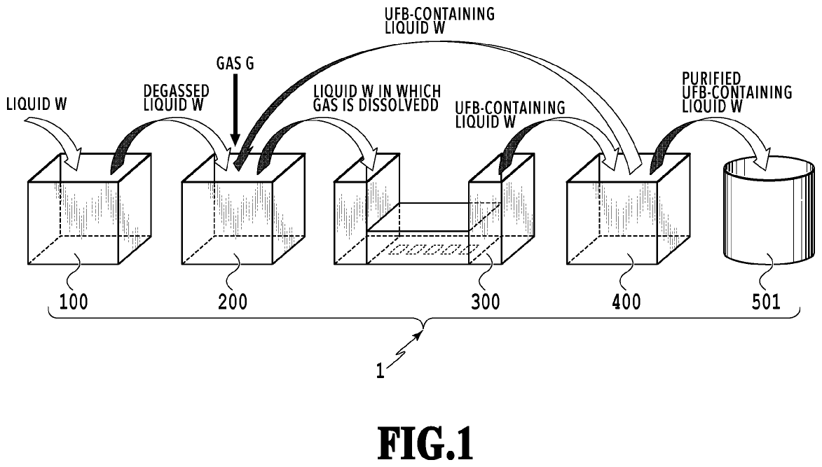

FIG. 1 is a diagram illustrating an example of a UFB generating apparatus applicable to the present invention. A UFB generating apparatus 1 of this embodiment includes a pre-processing unit 100, dissolving unit 200, a T-UFB generating unit 300, a post-processing unit 400, and a collecting unit 501. Each unit performs unique processing on a liquid W such as tap water supplied to the pre-processing unit 100 in the above order, and the thus-processed liquid W is collected as a T-UFB-containing liquid by the collecting unit 501. Functions and configurations of the units are described below. Although details are described later, UFBs generated by utilizing the film boiling caused by rapid heating are referred to as thermal-ultrafine bubbles (T-UFBs) in this specification.

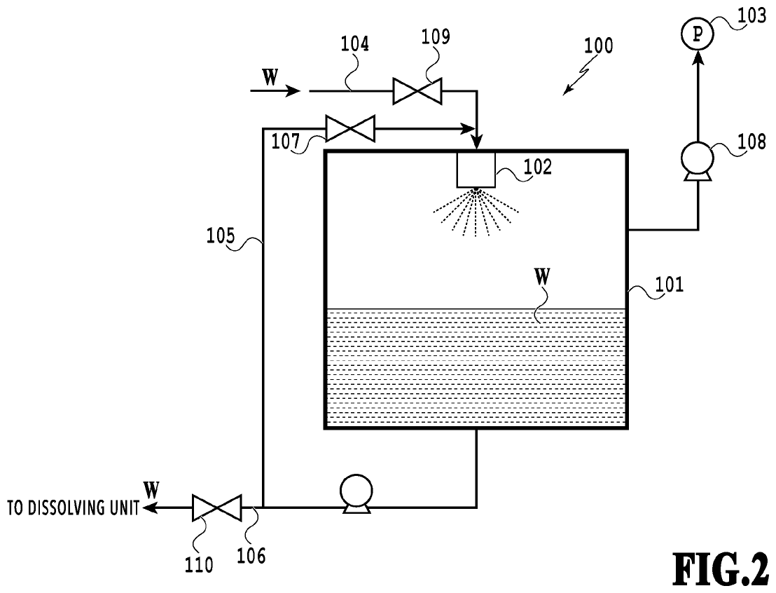

FIG. 2 is a schematic configuration diagram of the pre-processing unit 100. The pre-processing unit 100 of this embodiment performs a degassing treatment on the supplied liquid W. The pre-processing unit 100 mainly includes a degassing container 101, a shower head 102, a depressurizing pump 103, a liquid introduction passage 104, a liquid circulation passage 105, and a liquid discharge passage 106. For example, the liquid W such as tap water is supplied to the degassing container 101 from the liquid introduction passage 104 through a valve 109. In this process, the shower head 102 provided in the degassing container 101 sprays a mist of the liquid W in the degassing container 101. The shower head 102 is for prompting the gasification of the liquid W; however, a centrifugal and the like may be used instead as the mechanism for producing the gasification prompt effect.

When a certain amount of the liquid W is reserved in the degassing container 101 and then the depressurizing pump 103 is activated with all the valves closed, already-gasified gas components are discharged, and gasification and discharge of gas components dissolved in the liquid W are also prompted. In this process, the internal pressure of the degassing container 101 may be depressurized to around several hundreds to thousands of Pa (1.0 Torr to 10.0 Torr) while checking a manometer 108. The gases to be removed by the pre-processing unit 100 includes nitrogen, oxygen, argon, carbon dioxide, and so on, for example.

The above-described degassing processing can be repeatedly performed on the same liquid W by utilizing the liquid circulation passage 105. Specifically, the shower head 102 is operated with the valve 109 of the liquid introduction passage 104 and a valve 110 of the liquid discharge passage 106 closed and a valve 107 of the liquid circulation passage 105 opened. This allows the liquid W reserved in the degassing container 101 and degassed once to be resprayed in the degassing container 101 from the shower head 102. In addition, with the depressurizing pump 103 operated, the gasification processing by the shower head 102 and the degassing processing by the depressurizing pump 103 are repeatedly performed on the same liquid W. Every time the above processing utilizing the liquid circulation passage 105 is performed repeatedly, it is possible to decrease the gas components contained in the liquid W in stages. Once the liquid W degassed to a desired purity is obtained, the liquid W is transferred to the dissolving unit 200 through the liquid discharge passage 106 with the valve 110 opened.

FIG. 2 illustrates the degassing unit 100 that depressurizes the gas part to gasify the solute; however, the method of degassing the solution is not limited thereto. For example, a heating and boiling method for boiling the liquid W to gasify the solute may be employed, or a film degassing method for increasing the interface between the liquid and the gas using hollow fibers. A SEPAREL series (produced by DIC corporation) is commercially supplied as the degassing module using the hollow fibers. The SEPAREL series uses poly(4-methylpentene-1) (PMP) for the raw material of the hollow fibers and is used for removing air bubbles from ink and the like mainly supplied for a piezo head. In addition, two or more of an evacuating method, the heating and boiling method, and the film degassing method may be used together.

With the above-described degassing processing performed as pre-processing, it is possible to increase the purity and the solubility of a desired gas with respect to the liquid W in the dissolving processing described later. Additionally, it is possible to increase the purity of desired UFBs contained in the liquid W in the T-UFB generating unit described later. That is, it is possible to efficiently generate a UFB-containing liquid (ultra-fine bubble-containing liquid) with high purity by providing the pre-processing unit 100 to precede the dissolving unit 200 and the T-UFB generating unit 300.

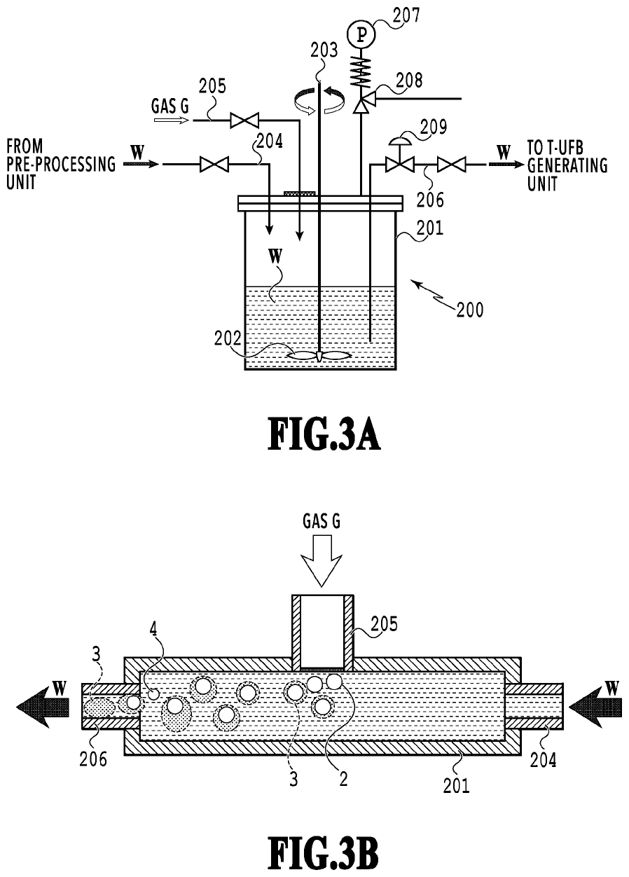

FIGS. 3A and 3B are a schematic configuration diagram of the dissolving unit 200 and a diagram for describing the dissolving states in the liquid. The dissolving unit 200 is a unit for dissolving a desired gas into the liquid W supplied from the pre-processing unit 100. The dissolving unit 200 of this embodiment mainly includes a dissolving container 201, a rotation shaft 203 provided with a rotation plate 202, a liquid introduction passage 204, a gas introduction passage 205, a liquid discharge passage 206, and a pressurizing pump 207.

The liquid W supplied from the pre-processing unit 100 is supplied and reserved into the dissolving container 201 through the liquid introduction passage 204. Meanwhile, a gas G is supplied to the dissolving container 201 through the gas introduction passage 205.

Once predetermined amounts of the liquid W and the gas G are reserved in the dissolving container 201, the pressurizing pump 207 is activated to increase the internal pressure of the dissolving container 201 to about 0.5 MPa. A safety valve 208 is arranged between the pressurizing pump 207 and the dissolving container 201. With the rotation plate 202 in the liquid rotated via the rotation shaft 203, the gas G supplied to the dissolving container 201 is transformed into air bubbles, and the contact area between the gas G and the liquid W is increased to prompt the dissolution into the liquid W. This operation is continued until the solubility of the gas G reaches almost the maximum saturation solubility. In this case, a unit for decreasing the temperature of the liquid may be provided to dissolve the gas as much as possible. When the gas is with low solubility, it is also possible to increase the internal pressure of the dissolving container 201 to 0.5 MPa or higher. In this case, the material and the like of the container need to be the optimum for safety sake.

Once the liquid W in which the components of the gas G are dissolved at a desired concentration is obtained, the liquid W is discharged through the liquid discharge passage 206 and supplied to the T-UFB generating unit 300. In this process, a back-pressure valve 209 adjusts the flow pressure of the liquid W to prevent excessive increase of the pressure during the supplying.

FIG. 3B is a diagram schematically illustrating the dissolving states of the gas G put in the dissolving container 201. An air bubble 2 containing the components of the gas G put in the liquid W is dissolved from a portion in contact with the liquid W. The air bubble 2 thus shrinks gradually, and a gas-dissolved liquid 3 then appears around the air bubble 2. Since the air bubble 2 is affected by the buoyancy, the air bubble 2 may be moved to a position away from the center of the gas-dissolved liquid 3 or be separated out from the gas-dissolved liquid 3 to become a residual air bubble 4. Specifically, in the liquid W to be supplied to the T-UFB generating unit 300 through the liquid discharge passage 206, there is a mix of the air bubbles 2 surrounded by the gas-dissolved liquids 3 and the air bubbles 2 and the gas-dissolved liquids 3 separated from each other.

The gas-dissolved liquid 3 in the drawings means “a region of the liquid W in which the dissolution concentration of the gas G mixed therein is relatively high.” In the gas components actually dissolved in the liquid W, the concentration of the gas components in the gas-dissolved liquid 3 is the highest at a portion surrounding the air bubble 2. In a case where the gas-dissolved liquid 3 is separated from the air bubble 2 the concentration of the gas components of the gas-dissolved liquid 3 is the highest at the center of the region, and the concentration is continuously decreased as away from the center. That is, although the region of the gas-dissolved liquid 3 is surrounded by a broken line in FIG. 3 for the sake of explanation, such a clear boundary does not actually exist. In addition, in the present invention, a gas that cannot be dissolved completely may be accepted to exist in the form of an air bubble in the liquid.

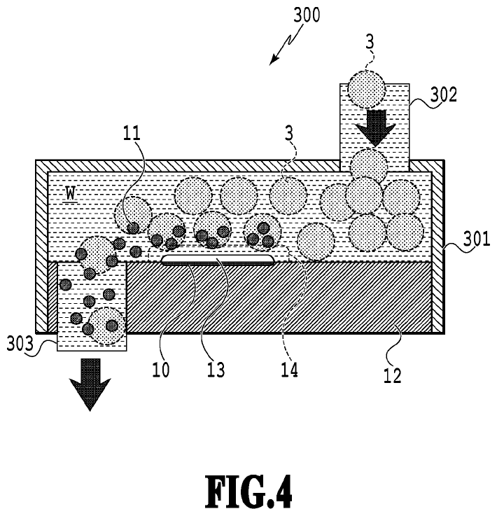

FIG. 4 is a schematic configuration diagram of the T-UFB generating unit 300. The T-UFB generating unit 300 mainly includes a chamber 301, a liquid introduction passage 302, and a liquid discharge passage 303. The flow from the liquid introduction passage 302 to the liquid discharge passage 303 through the chamber 301 is formed by a not-illustrated flow pump. Various pumps including a diaphragm pump, a gear pump, and a screw pump may be employed as the flow pump. In in the liquid W introduced from the liquid introduction passage 302, the gas-dissolved liquid 3 of the gas G put by the dissolving unit 200 is mixed.

An element substrate 12 provided with a heating element 10 is arranged on a bottom section of the chamber 301. With a predetermined voltage pulse applied to the heating element 10, a bubble 13 generated by the film boiling (hereinafter, also referred to as a film boiling bubble 13) is generated in a region in contact with the heating element 10. Then, an ultrafine bubble (UFB) 11 containing the gas G is generated caused by expansion and shrinkage of the film boiling bubble 13. As a result, a UFB-containing liquid W containing many UFBs 11 is discharged from the liquid discharge passage 303.

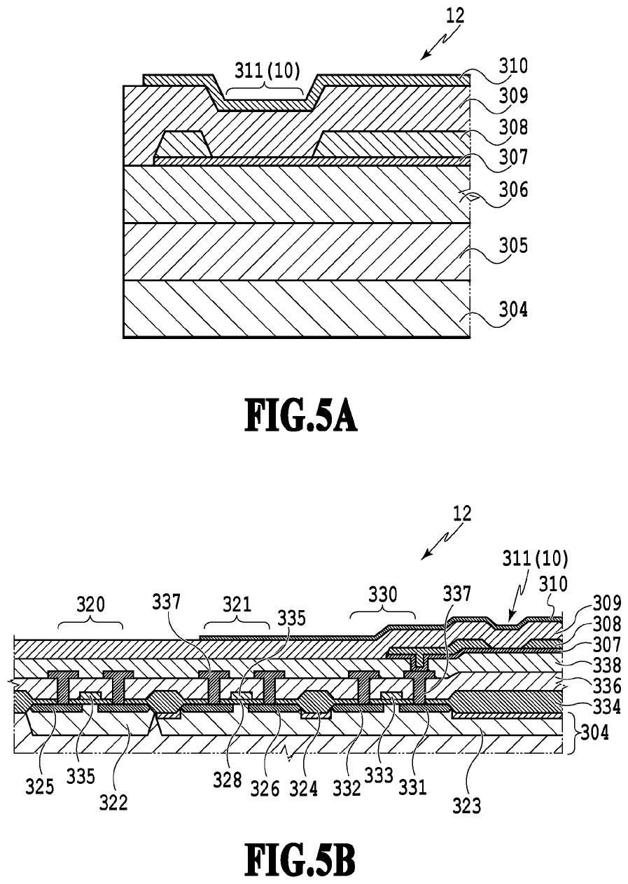

FIGS. 5A and 5B are diagrams for illustrating a detailed configuration of the heating element 10. FIG. 5A illustrates a closeup view of the heating element 10, and FIG. 5B illustrates a cross-sectional view of a wider region of the element substrate 12 including the heating element 10.

As illustrated in FIG. 5A, in the element substrate 12 of this embodiment, a thermal oxide film 305 as a heat-accumulating layer and an interlaminar film 306 also served as a heat-accumulating layer are laminated on a surface of a silicon substrate 304. An SiO₂ film or an SiN film may be used as the interlaminar film 306. A resistive layer 307 is formed on a surface of the interlaminar film 306, and a wiring 308 is partially formed on a surface of the resistive layer 307. An Al-alloy wiring of Al, Al—Si, Al—Cu, or the like may be used as the wiring 308. A protective layer 309 made of an SiO₂ film or an Si₃N₄ film is formed on surfaces of the wiring 308, the resistive layer 307, and the interlaminar film 306.

A cavitation-resistant film 310 for protecting the protective layer 309 from chemical and physical impacts due to the heat evolved by the resistive layer 307 is formed on a portion and around the portion on the surface of the protective layer 309, the portion corresponding to a heat-acting portion 311 that eventually becomes the heating element 10. A region on the surface of the resistive layer 307 in which the wiring 308 is not formed is the heat-acting portion 311 in which the resistive layer 307 evolves heat. The heating portion of the resistive layer 307 on which the wiring 308 is not formed functions as the heating element (heater) 10. As described above, the layers in the element substrate 12 are sequentially formed on the surface of the silicon substrate 304 by a semiconductor production technique, and the heat-acting portion 311 is thus provided on the silicon substrate 304.

The configuration illustrated in the drawings is an example, and various other configurations are applicable. For example, a configuration in which the laminating order of the resistive layer 307 and the wiring 308 is opposite, and a configuration in which an electrode is connected to a lower surface of the resistive layer 307 (so-called a plug electrode configuration) are applicable. In other words, as described later, any configuration may be applied as long as the configuration allows the heat-acting portion 311 to heat the liquid for generating the film boiling in the liquid.

FIG. 5B is an example of a cross-sectional view of a region including a circuit connected to the wiring 308 in the element substrate 12. An N-type well region 322 and a P-type well region 323 are partially provided in a top layer of the silicon substrate 304, which is a P-type conductor. AP-MOS 320 is formed in the N-type well region 322 and an N-MOS 321 is formed in the P-type well region 323 by introduction and diffusion of impurities by the ion implantation and the like in the general MOS process.

The P-MOS 320 includes a source region 325 and a drain region 326 formed by partial introduction of N-type or P-type impurities in a top layer of the N-type well region 322, a gate wiring 335, and so on. The gate wiring 335 is deposited on a part of a top surface of the N-type well region 322 excluding the source region 325 and the drain region 326, with a gate insulation film 328 of several hundreds of A in thickness interposed between the gate wiring 335 and the top surface of the N-type well region 322.

The N-MOS 321 includes the source region 325 and the drain region 326 formed by partial introduction of N-type or P-type impurities in a top layer of the P-type well region 323, the gate wiring 335, and so on. The gate wiring 335 is deposited on a part of a top surface of the P-type well region 323 excluding the source region 325 and the drain region 326, with the gate insulation film 328 of several hundreds of A in thickness interposed between the gate wiring 335 and the top surface of the P-type well region 323. The gate wiring 335 is made of polysilicon of 3000 Å to 5000 Å in thickness deposited by the CVD method. A C-MOS logic is constructed with the P-MOS 320 and the N-MOS 321.

In the P-type well region 323, an N-MOS transistor 330 for driving an electrothermal conversion element (heating resistance element) is formed on a portion different from the portion including the N-MOS 321. The N-MOS transistor 330 includes a source region 332 and a drain region 331 partially provided in the top layer of the P-type well region 323 by the steps of introduction and diffusion of impurities, a gate wiring 333, and so on. The gate wiring 333 is deposited on a part of the top surface of the P-type well region 323 excluding the source region 332 and the drain region 331, with the gate insulation film 328 interposed between the gate wiring 333 and the top surface of the P-type well region 323.

In this example, the N-MOS transistor 330 is used as the transistor for driving the electrothermal conversion element. However, the transistor for driving is not limited to the N-MOS transistor 330, and any transistor may be used as long as the transistor has a capability of driving multiple electrothermal conversion elements individually and can implement the above-described fine configuration. Although the electrothermal conversion element and the transistor for driving the electrothermal conversion element are formed on the same substrate in this example, those may be formed on different substrates separately.

An oxide film separation region 324 is formed by field oxidation of 5000 Å to 10000 Å in thickness between the elements, such as between the P-MOS 320 and the N-MOS 321 and between the N-MOS 321 and the N-MOS transistor 330. The oxide film separation region 324 separates the elements. A portion of the oxide film separation region 324 corresponding to the heat-acting portion 311 functions as a heat-accumulating layer 334, which is the first layer on the silicon substrate 304.

An interlayer insulation film 336 including a PSG film, a BPSG film, or the like of about 7000 Å in thickness is formed by the CVD method on each surface of the elements such as the P-MOS 320, the N-MOS 321, and the N-MOS transistor 330. After the interlayer insulation film 336 is made flat by heat treatment, an Al electrode 337 as a first wiring layer is formed in a contact hole penetrating through the interlayer insulation film 336 and the gate insulation film 328. On surfaces of the interlayer insulation film 336 and the Al electrode 337, an interlayer insulation film 338 including an SiO₂ film of 10000 Å to 15000 Å in thickness is formed by a plasma CVD method. On the surface of the interlayer insulation film 338, a resistive layer 307 including a TaSiN film of about 500 Å in thickness is formed by a co-sputter method on portions corresponding to the heat-acting portion 311 and the N-MOS transistor 330. The resistive layer 307 is electrically connected with the Al electrode 337 near the drain region 331 via a through-hole formed in the interlayer insulation film 338. On the surface of the resistive layer 307, the wiring 308 of Al as a second wiring layer for a wiring to each electrothermal conversion element is formed. The protective layer 309 on the surfaces of the wiring 308, the resistive layer 307, and the interlayer insulation film 338 includes an SiN film of 3000 Å in thickness formed by the plasma CVD method. The cavitation-resistant film 310 deposited on the surface of the protective layer 309 includes a thin film of about 2000 Å in thickness, which is at least one metal selected from the group consisting of Ta, Fe, Ni, Cr, Ge, Ru, Zr, Ir, and the like. Various materials other than the above-described TaSiN such as TaN0.8, CrSiN, TaAl, WSiN, and the like can be applied as long as the material can generate the film boiling in the liquid.

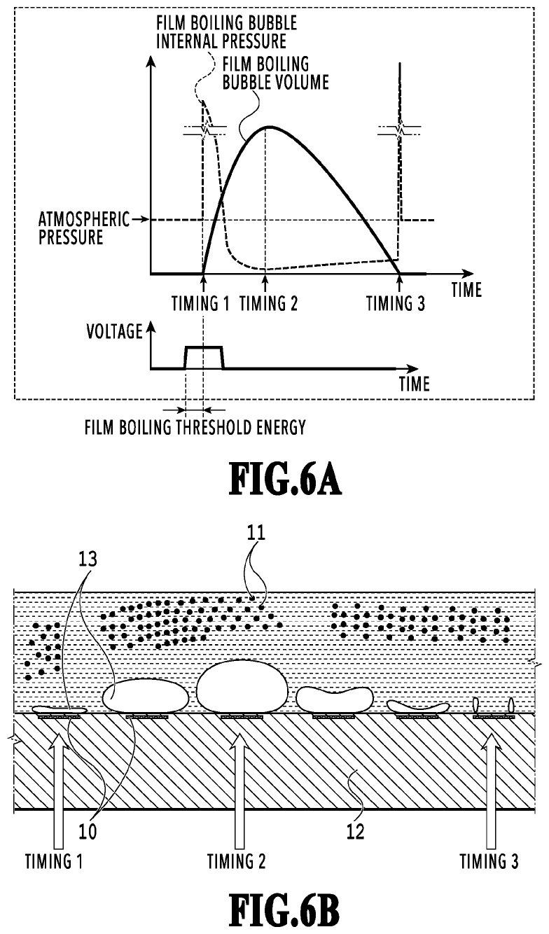

FIGS. 6A and 6B are diagrams illustrating the states of the film boiling when a predetermined voltage pulse is applied to the heating element 10. In this case, the case of generating the film boiling under atmospheric pressure is described. In FIG. 6A, the horizontal axis represents time. The vertical axis in the lower graph represents a voltage applied to the heating element 10, and the vertical axis in the upper graph represents the volume and the internal pressure of the film boiling bubble 13 generated by the film boiling. On the other hand, FIG. 6B illustrates the states of the film boiling bubble 13 in association with timings 1 to 3 shown in FIG. 6A. Each of the states is described below in chronological order. The UFBs 11 generated by the film boiling as described later are mainly generated near a surface of the film boiling bubble 13. The states illustrated in FIG. 6B are the states where the UFBs 11 generated by the generating unit 300 are resupplied to the dissolving unit 200 through the circulation route, and the liquid containing the UFBs 11 is resupplied to the liquid passage of the generating unit 300, as illustrated in FIG. 1.

Before a voltage is applied to the heating element 10, the atmospheric pressure is substantially maintained in the chamber 301. Once a voltage is applied to the heating element 10, the film boiling is generated in the liquid in contact with the heating element 10, and a thus-generated air bubble (hereinafter, referred to as the film boiling bubble 13) is expanded by a high pressure acting from inside (timing 1). A bubbling pressure in this process is expected to be around 8 to 10 MPa, which is a value close to a saturation vapor pressure of water.

The time for applying a voltage (pulse width) is around 0.5 μsec to 10.0 μsec, and the film boiling bubble 13 is expanded by the inertia of the pressure obtained in timing 1 even after the voltage application. However, a negative pressure generated with the expansion is gradually increased inside the film boiling bubble 13, and the negative pressure acts in a direction to shrink the film boiling bubble 13. After a while, the volume of the film boiling bubble 13 becomes the maximum in timing 2 when the inertial force and the negative pressure are balanced, and thereafter the film boiling bubble 13 shrinks rapidly by the negative pressure.

In the disappearance of the film boiling bubble 13, the film boiling bubble 13 disappears not in the entire surface of the heating element 10 but in one or more extremely small regions. For this reason, on the heating element 10, further greater force than that in the bubbling in timing 1 is generated in the extremely small region in which the film boiling bubble 13 disappears (timing 3).

The generation, expansion, shrinkage, and disappearance of the film boiling bubble 13 as described above are repeated every time a voltage pulse is applied to the heating element 10, and new UFBs 11 are generated each time.

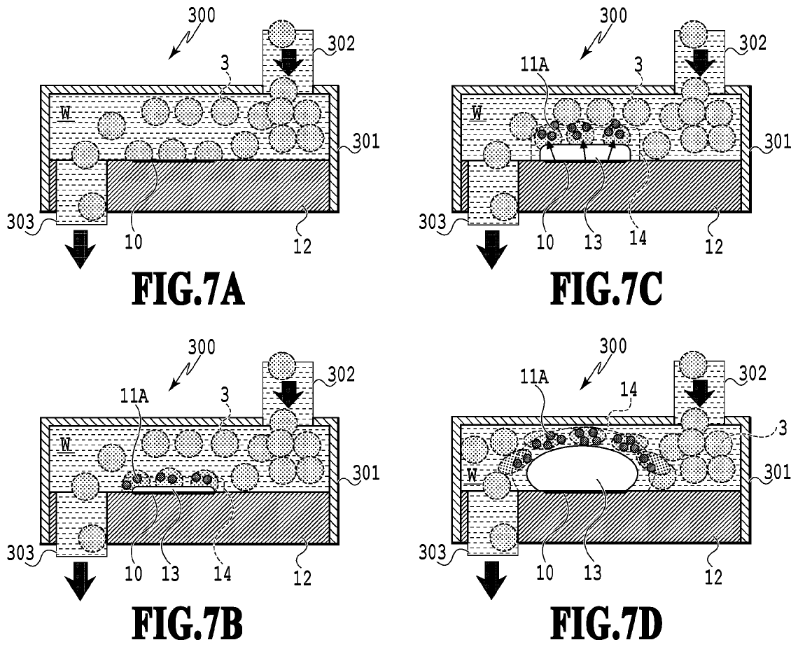

The states of generation of the UFBs 11 in each process of the generation, expansion, shrinkage, and disappearance of the film boiling bubble 13 are further described in detail with reference to FIGS. 7A to 10B.

FIGS. 7A to 7D are diagrams schematically illustrating the states of generation of the UFBs 11 caused by the generation and the expansion of the film boiling bubble 13. FIG. 7A illustrates the state before the application of a voltage pulse to the heating element 10. The liquid W in which the gas-dissolved liquids 3 are mixed flows inside the chamber 301.

FIG. 7B illustrates the state where a voltage is applied to the heating element 10, and the film boiling bubble 13 is evenly generated in almost all over the region of the heating element 10 in contact with the liquid W. When a voltage is applied, the surface temperature of the heating element 10 rapidly increases at a speed of 10° C./psec. The film boiling occurs at a time point when the temperature reaches almost 300° C., and the film boiling bubble 13 is thus generated.

Thereafter, the surface temperature of the heating element 10 keeps increasing to around 600 to 800° C. during the pulse application, and the liquid around the film boiling bubble 13 is rapidly heated as well. In FIG. 7B, a region of the liquid that is around the film boiling bubble 13 and to be rapidly heated is indicated as a not-yet-bubbling high temperature region 14. The gas-dissolved liquid 3 within the not-yet-bubbling high temperature region 14 exceeds the thermal dissolution limit and is vaporized to become the UFB. The thus-vaporized air bubbles have diameters of around 10 nm to 100 nm and large gas-liquid interface energy. Thus, the air bubbles float independently in the liquid W without disappearing in a short time. In this embodiment, the air bubbles generated by the thermal action from the generation to the expansion of the film boiling bubble 13 are called first UFBs 11A.

FIG. 7C illustrates the state where the film boiling bubble 13 is expanded. Even after the voltage pulse application to the heating element 10, the film boiling bubble 13 continues expansion by the inertia of the force obtained from the generation thereof, and the not-yet-bubbling high temperature region 14 is also moved and spread by the inertia. Specifically, in the process of the expansion of the film boiling bubble 13, the gas-dissolved liquid 3 within the not-yet-bubbling high temperature region 14 is vaporized as a new air bubble and becomes the first UFB 11A.

FIG. 7D illustrates the state where the film boiling bubble 13 has the maximum volume. As the film boiling bubble 13 is expanded by the inertia, the negative pressure inside the film boiling bubble 13 is gradually increased along with the expansion, and the negative pressure acts to shrink the film boiling bubble 13. At a time point when the negative pressure and the inertial force are balanced, the volume of the film boiling bubble 13 becomes the maximum, and then the shrinkage is started.

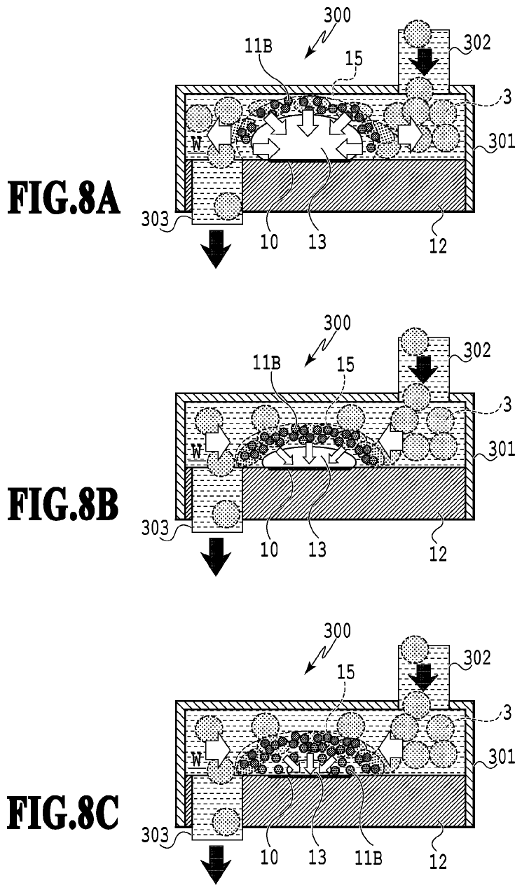

FIGS. 8A to 8C are diagrams illustrating the states of generation of the UFBs 11 caused by the shrinkage of the film boiling bubble 13. FIG. 8A illustrates the state where the film boiling bubble 13 starts shrinking. Although the film boiling bubble 13 starts shrinking, the surrounding liquid W still has the inertial force in the expansion direction. Because of this, the inertial force acting in the direction of going away from the heating element 10 and the force going toward the heating element 10 caused by the shrinkage of the film boiling bubble 13 act in a surrounding region extremely close to the film boiling bubble 13, and the region is depressurized. The region is indicated in the drawings as a not-yet-bubbling negative pressure region 15.

The gas-dissolved liquid 3 within the not-yet-bubbling negative pressure region 15 exceeds the pressure dissolution limit and is vaporized to become an air bubble. The thus-vaporized air bubbles have diameters of about 100 nm and thereafter float independently in the liquid W without disappearing in a short time. In this embodiment, the air bubbles vaporized by the pressure action during the shrinkage of the film boiling bubble 13 are called the second UFBs 11B.

FIG. 8B illustrates a process of the shrinkage of the film boiling bubble 13. The shrinking speed of the film boiling bubble 13 is accelerated by the negative pressure, and the not-yet-bubbling negative pressure region 15 is also moved along with the shrinkage of the film boiling bubble 13. Specifically, in the process of the shrinkage of the film boiling bubble 13, the gas-dissolved liquids 3 within a part over the not-yet-bubbling negative pressure region 15 are precipitated one after another and become the second UFBs 11B.

FIG. 8C illustrates the state immediately before the disappearance of the film boiling bubble 13. Although the moving speed of the surrounding liquid W is also increased by the accelerated shrinkage of the film boiling bubble 13, a pressure loss occurs due to a flow passage resistance in the chamber 301. As a result, the region occupied by the not-yet-bubbling negative pressure region 15 is further increased, and a number of the second UFBs 11B are generated.

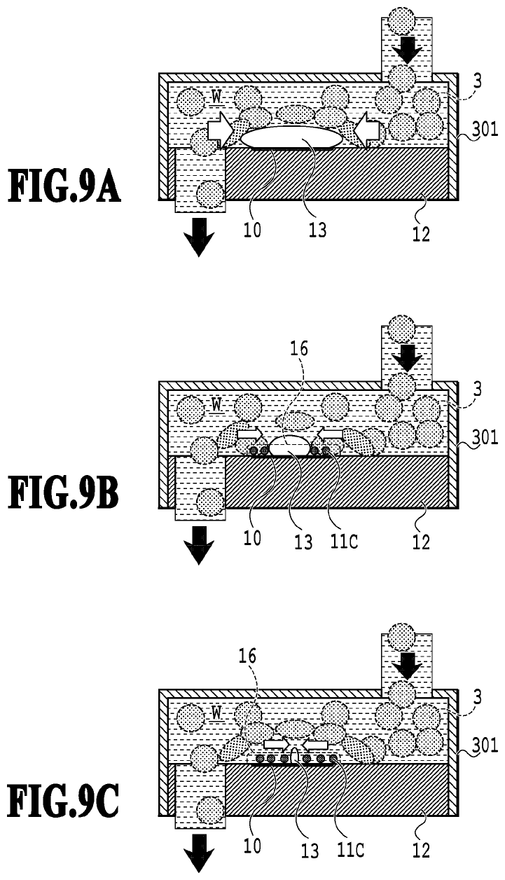

FIGS. 9A to 9C are diagrams illustrating the states of generation of the UFBs by reheating of the liquid W during the shrinkage of the film boiling bubble 13. FIG. 9A illustrates the state where the surface of the heating element 10 is covered with the shrinking film boiling bubble 13.

FIG. 9B illustrates the state where the shrinkage of the film boiling bubble 13 has progressed, and a part of the surface of the heating element 10 comes in contact with the liquid W. In this state, there is heat left on the surface of the heating element 10, but the heat is not high enough to cause the film boiling even if the liquid W comes in contact with the surface. A region of the liquid to be heated by coming in contact with the surface of the heating element 10 is indicated in the drawings as a not-yet-bubbling reheated region 16. Although the film boiling is not made, the gas-dissolved liquid 3 within the not-yet-bubbling reheated region 16 exceeds the thermal dissolution limit and is vaporized. In this embodiment, the air bubbles generated by the reheating of the liquid W during the shrinkage of the film boiling bubble 13 are called the third UFBs 11C.

FIG. 9C illustrates the state where the shrinkage of the film boiling bubble 13 has further progressed. The smaller the film boiling bubble 13, the greater the region of the heating element 10 in contact with the liquid W, and the third UFBs 11C are generated until the film boiling bubble 13 disappears.

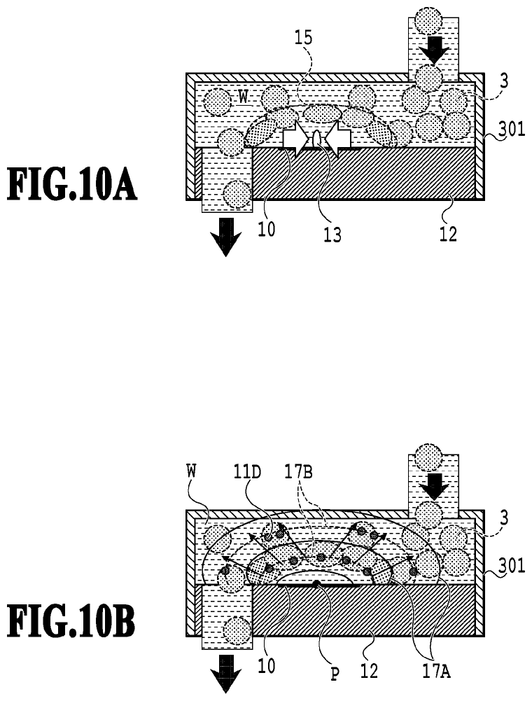

FIGS. 10A and 10B are diagrams illustrating the states of generation of the UFBs caused by an impact from the disappearance of the film boiling bubble 13 generated by the film boiling (that is, a type of cavitation). FIG. 10A illustrates the state immediately before the disappearance of the film boiling bubble 13. In this state, the film boiling bubble 13 shrinks rapidly by the internal negative pressure, and the not-yet-bubbling negative pressure region 15 surrounds the film boiling bubble 13.

FIG. 10B illustrates the state immediately after the film boiling bubble 13 disappears at a point P When the film boiling bubble 13 disappears, acoustic waves ripple concentrically from the point P as a starting point due to the impact of the disappearance. The acoustic wave is a collective term of an elastic wave that is propagated through anything regardless of gas, liquid, and solid. In this embodiment, compression waves of the liquid W, which are a high pressure surface 17A and a low pressure surface 17B of the liquid W, are propagated alternately.

In this case, the gas-dissolved liquid 3 within the not-yet-bubbling negative pressure region 15 is resonated by the shock waves made by the disappearance of the film boiling bubble 13, and the gas-dissolved liquid 3 exceeds the pressure dissolution limit and the phase transition is made in timing when the low pressure surface 17B passes therethrough. Specifically, a number of air bubbles are vaporized in the not-yet-bubbling negative pressure region 15 simultaneously with the disappearance of the film boiling bubble 13. In this embodiment, the air bubbles generated by the shock waves made by the disappearance of the film boiling bubble 13 are called fourth UFBs 11D.

The fourth UFBs 11D generated by the shock waves made by the disappearance of the film boiling bubble 13 suddenly appear in an extremely short time (1 pS or less) in an extremely narrow thin film-shaped region. The diameter is sufficiently smaller than that of the first to third UFBs, and the gas-liquid interface energy is higher than that of the first to third UFBs. For this reason, it is considered that the fourth UFBs 11D have different characteristics from the first to third UFBs 11A to 11C and generate different effects.

Additionally, the fourth UFBs 11D are evenly generated in many parts of the region of the concentric sphere in which the shock waves are propagated, and the fourth UFBs 11D evenly exist in the chamber 301 from the generation thereof. Although many first to third UFBs already exist in the timing of the generation of the fourth UFBs 11D, the presence of the first to third UFBs does not affect the generation of the fourth UFBs 11D greatly. It is also considered that the first to third UFBs do not disappear due to the generation of the fourth UFBs 11D.

As described above, it is expected that the UFBs 11 are generated in the multiple stages from the generation to the disappearance of the film boiling bubble 13 by the heat generation of the heating element 10. Although the above example illustrates the stages to the disappearance of the film boiling bubble 13, the way of generating the UFBs is not limited thereto. For example, with the generated film boiling bubble 13 communicating with the atmospheric air before the bubble disappearance, the UFBs can be generated also if the film boiling bubble 13 does not reach the disappearance.

Next, remaining properties of the UFBs are described. The higher the temperature of the liquid, the lower the dissolution properties of the gas components, and the lower the temperature, the higher the dissolution properties of the gas components. In other words, the phase transition of the dissolved gas components is prompted and the generation of the UFBs becomes easier as the temperature of the liquid is higher. The temperature of the liquid and the solubility of the gas are in the inverse relationship, and the gas exceeding the saturation solubility is transformed into air bubbles and appeared in the liquid as the liquid temperature increases.

Therefore, when the temperature of the liquid rapidly increases from normal temperature, the dissolution properties are decreased without stopping, and the generation of the UFBs starts. The thermal dissolution properties are decreased as the temperature increases, and a number of the UFBs are generated.

Conversely, when the temperature of the liquid decreases from normal temperature, the dissolution properties of the gas are increased, and the generated UFBs are more likely to be liquefied. However, such temperature is sufficiently lower than normal temperature. Additionally, since the once generated UFBs have a high internal pressure and large gas-liquid interface energy even when the temperature of the liquid decreases, it is highly unlikely that there is exerted a sufficiently high pressure to break such a gas-liquid interface. In other words, the once generated UFBs do not disappear easily as long as the liquid is stored at normal temperature and normal pressure.

In this embodiment, the first UFBs 11A described with FIGS. 7A to 7C and the third UFBs 11C described with FIGS. 9A to 9C can be described as UFBs that are generated by utilizing such thermal dissolution properties of gas.

On the other hand, in the relationship between the pressure and the dissolution properties of liquid, the higher the pressure of the liquid, the higher the dissolution properties of the gas, and the lower the pressure, the lower the dissolution properties. In other words, the phase transition to the gas of the gas-dissolved liquid dissolved in the liquid is prompted and the generation of the UFBs becomes easier as the pressure of the liquid is lower. Once the pressure of the liquid becomes lower than normal pressure, the dissolution properties are decreased instantly, and the generation of the UFBs starts. The pressure dissolution properties are decreased as the pressure decreases, and a number of the UFBs are generated.

Conversely, when the pressure of the liquid increases to be higher than normal temperature, the dissolution properties of the gas are increased, and the generated UFBs are more likely to be liquefied. However, such pressure is sufficiently higher than the atmospheric pressure. Additionally, since the once generated UFBs have a high internal pressure and large gas-liquid interface energy even when the pressure of the liquid increases, it is highly unlikely that there is exerted a sufficiently high pressure to break such a gas-liquid interface. In other words, the once generated UFBs do not disappear easily as long as the liquid is stored at normal temperature and normal pressure.

In this embodiment, the second UFBs 11B described with FIGS. 8A to 8C and the fourth UFBs 11D described with FIGS. 10A to 10C can be described as UFBs that are generated by utilizing such pressure dissolution properties of gas.

Those first to fourth UFBs generated by different causes are described individually above; however, the above-described generation causes occur simultaneously with the event of the film boiling. Thus, at least two types of the first to the fourth UFBs may be generated at the same time, and these generation causes may cooperate to generate the UFBs. It should be noted that it is common for all the generation causes to be induced by the volume change of the film boiling bubble generated by the film boiling phenomenon. In this specification, the method of generating the UFBs by utilizing the film boiling caused by the rapid heating as described above is referred to as a thermal-ultrafine bubble (T-UFB) generating method. Additionally, the UFBs generated by the T-UFB generating method are referred to as T-UFBs, and the liquid containing the T-UFBs generated by the T-UFB generating method is referred to as a T-UFB-containing liquid.

Almost all the air bubbles generated by the T-UFB generating method are 1.0 μm or less, and milli-bubbles and microbubbles are unlikely to be generated. That is, the T-UFB generating method allows dominant and efficient generation of the UFBs. Additionally, the T-UFBs generated by the T-UFB generating method have larger gas-liquid interface energy than that of the UFBs generated by a conventional method, and the T-UFBs do not disappear easily as long as being stored at normal temperature and normal pressure. Moreover, even if new T-UFBs are generated by new film boiling, it is possible to prevent disappearance of the already generated T-UFBs due to the impact from the new generation. That is, it can be said that the number and the concentration of the T-UFBs contained in the T-UFB-containing liquid have the hysteresis properties depending on the number of times the film boiling is made in the T-UFB-containing liquid. In other words, it is possible to adjust the concentration of the T-UFBs contained in the T-UFB-containing liquid by controlling the number of the heating elements provided in the T-UFB generating unit 300 and the number of the voltage pulse application to the heating elements.

Reference to FIG. 1 is made again. Once the T-UFB-containing liquid W with a desired UFB concentration is generated in the T-UFB generating unit 300, the UFB-containing liquid W is supplied to the post-processing unit 400.

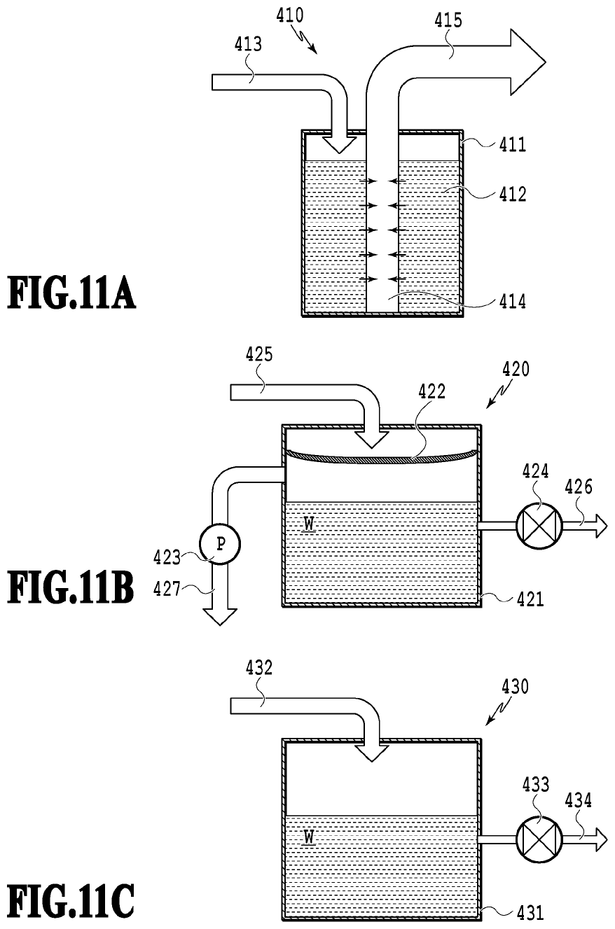

FIGS. 11A to 11C are diagrams illustrating configuration examples of the post-processing unit 400 of this embodiment. The post-processing unit 400 of this embodiment removes impurities in the UFB-containing liquid W in stages in the order from inorganic ions, organic substances, and insoluble solid substances.

FIG. 11A illustrates a first post-processing mechanism 410 that removes the inorganic ions. The first post-processing mechanism 410 includes an exchange container 411, cation exchange resins 412, a liquid introduction passage 413, a collecting pipe 414, and a liquid discharge passage 415. The exchange container 411 stores the cation exchange resins 412. The UFB-containing liquid W generated by the T-UFB generating unit 300 is injected to the exchange container 411 through the liquid introduction passage 413 and absorbed into the cation exchange resins 412 such that the cations as the impurities are removed. Such impurities include metal materials peeled off from the element substrate 12 of the T-UFB generating unit 300, such as SiO₂, SiN, SiC, Ta, Al₂O₃, Ta₂O₅, and Ir.

The cation exchange resins 412 are synthetic resins in which a functional group (ion exchange group) is introduced in a high polymer matrix having a three-dimensional network, and the appearance of the synthetic resins are spherical particles of around 0.4 to 0.7 mm. A general high polymer matrix is the styrene-divinylbenzene copolymer, and the functional group may be that of methacrylic acid series and acrylic acid series, for example. However, the above material is an example. As long as the material can remove desired inorganic ions effectively, the above material can be changed to various materials. The UFB-containing liquid W absorbed in the cation exchange resins 412 to remove the inorganic ions is collected by the collecting pipe 414 and transferred to the next step through the liquid discharge passage 415.

FIG. 11B illustrates a second post-processing mechanism 420 that removes the organic substances. The second post-processing mechanism 420 includes a storage container 421, a filtration filter 422, a vacuum pump 423, a valve 424, a liquid introduction passage 425, a liquid discharge passage 426, and an air suction passage 427. Inside of the storage container 421 is divided into upper and lower two regions by the filtration filter 422. The liquid introduction passage 425 is connected to the upper region of the upper and lower two regions, and the air suction passage 427 and the liquid discharge passage 426 are connected to the lower region thereof. Once the vacuum pump 423 is driven with the valve 424 closed, the air in the storage container 421 is discharged through the air suction passage 427 to make the pressure inside the storage container 421 negative pressure, and the UFB-containing liquid W is thereafter introduced from the liquid introduction passage 425. Then, the UFB-containing liquid W from which the impurities are removed by the filtration filter 422 is reserved into the storage container 421.

The impurities removed by the filtration filter 422 include organic materials that may be mixed at a tube or each unit, such as organic compounds including silicon, siloxane, and epoxy, for example. A filter film usable for the filtration filter 422 includes a filter of a sub-μm-mesh (a filter of 1 μm or smaller in mesh diameter) that can remove bacteria, and a filter of a nm-mesh that can remove virus.

After a certain amount of the UFB-containing liquid W is reserved in the storage container 421, the vacuum pump 423 is stopped and the valve 424 is opened to transfer the T-UFB-containing liquid in the storage container 421 to the next step through the liquid discharge passage 426. Although the vacuum filtration method is employed as the method of removing the organic impurities herein, a gravity filtration method and a pressurized filtration can also be employed as the filtration method using a filter, for example.

FIG. 11C illustrates a third post-processing mechanism 430 that removes the insoluble solid substances. The third post-processing mechanism 430 includes a precipitation container 431, a liquid introduction passage 432, a valve 433, and a liquid discharge passage 434.

First, a predetermined amount of the UFB-containing liquid W is reserved into the precipitation container 431 through the liquid introduction passage 432 with the valve 433 closed, and leaving it for a while. Meanwhile, the solid substances in the UFB-containing liquid W are precipitated onto the bottom of the precipitation container 431 by gravity. Among the bubbles in the UFB-containing liquid, relatively large bubbles such as microbubbles are raised to the liquid surface by the buoyancy and also removed from the UFB-containing liquid. After a lapse of sufficient time, the valve 433 is opened, and the UFB-containing liquid W from which the solid substances and large bubbles are removed is transferred to the collecting unit 501 through the liquid discharge passage 434.

Reference to FIG. 1 is made again. The T-UFB-containing liquid W from which the impurities are removed by the post-processing unit 400 may be directly transferred to the collecting unit 501 or may be put back to the dissolving unit 200 again. In the latter case, the gas dissolution concentration of the T-UFB-containing liquid W that is decreased due to the generation of the T-UFBs can be compensated to the saturated state again by the dissolving unit 200. If new T-UFBs are generated by the T-UFB generating unit 300 after the compensation, it is possible to further increase the concentration of the UFBs contained in the T-UFB-containing liquid with the above-described properties. That is, it is possible to increase the concentration of the contained UFBs by the number of circulations through the dissolving unit 200, the T-UFB generating unit 300, and the post-processing unit 400, and it is possible to transfer the UFB-containing liquid W to the collecting unit 501 after a predetermined concentration of the contained UFBs is obtained.

Here, an effect of putting back the generated T-UFB-containing liquid W to the dissolving unit 200 again is simply described in accordance with details of specific testing performed by the present disclosures. First, in the T-UFB generating unit 300, 10000 pieces of the heating elements 10 were arranged on the element substrate 12. Industrial pure water was used as the liquid W and was flowed in the chamber 301 of the T-UFB generating unit 300 at a flow rate of 1.0 liter/hour. I this state, a voltage pulse with a voltage of 24 V and a pulse width of 1.0 μs was applied at a driving frequency of 10 KHz to the individual heating elements.

In a case where the generated T-UFB-containing liquid W was collected by the collecting unit 501 without putting back to the dissolving unit 200, that is, in a case where the number of circulation was one time, 3.6 billion pieces per mL of the UFBs were confirmed in the T-UFB-containing liquid W collected by the collecting unit 501. On the other hand, in a case where the operation of putting back the T-UFB-containing liquid W to the dissolving unit 200 was performed nine times, that is, in a case where the number of circulation was ten times, 36 billion pieces per mL of the UFBs were confirmed in the T-UFB-containing liquid W collected by the collecting unit 501. That is, it was confirmed that the UFB-containing concentration is increased in the proportion of the number of circulation. The number density of the UFBs as described above was obtained by counting the UFBs smaller than 1.0 m in diameter contained in the UFB-containing liquid W of a predetermined volume by using a measuring instrument (model number SALD-7500) manufactured by SHIMADZU CORPORATION.

The collecting unit 501 collects and stores the UFB-containing liquid W transferred from the post-processing unit 400. The T-UFB-containing liquid collected by the collecting unit 501 is a UFB-containing liquid with high purity from which various impurities are removed.

In the collecting unit 501, the UFB-containing liquid W may be classified by the size of the T-UFBs by performing some stages of filtration processing. Since it is expected that the temperature of the T-UFB-containing liquid W obtained by the T-UFB generating method is higher than normal temperature, the collecting unit 501 may be provided with a cooling unit. The cooling unit may be provided as a part of the post-processing unit 400.

The schematic description of the UFB generating apparatus 1 is given above; however, it is needless to say that the illustrated multiple units can be changed, and not all of them need to be prepared. Depending on the type of the liquid W and the gas G to be used and the intended use of the T-UFB-containing liquid to be generated, a part of the above-described units may be omitted, or another unit other than the above-described units may be added.

For example, when the gas to be contained by the UFBs is the atmospheric air, the degassing unit as the pre-processing unit 100 and the dissolving unit 200 can be omitted. On the other hand, when multiple kinds of gases are desired to be contained by the UFBs, another dissolving unit 200 may be added.

The functions of some units illustrated in FIG. 1 can be integrated into a single unit. For example, the dissolving unit 200 and the T-UFB generating unit 300 can be integrated by arranging the heating element 10 in the dissolving container 201 illustrated in FIGS. 3A and 3B. Specifically, an electrode type T-UFB module is disposed in a gas dissolving container (high-pressure chamber), and multiple heaters arranged in the module are driven to make film boiling. Such a configuration allows a single unit to generate T-UFBs containing a gas while dissolving the gas therein. In this case, with the T-UFB module arranged on a base of the gas dissolving container, a Marangoni flow occurs due to the heat generated by the heaters, and the liquid in the container can be agitated to some extent without providing a circulating and agitating unit.

The removing units for removing the impurities as illustrated in FIGS. 11A to 11C may be provided upstream of the T-UFB generating unit 300 as a part of the pre-processing unit or may be provided both upstream and downstream thereof. In a case where the liquid to be supplied to the UFB generating apparatus is tap water, rain water, contaminated water, or the like, there may be included organic and inorganic impurities in the liquid. If such a liquid W including the impurities is supplied to the T-UFB generating unit 300, there occurs a risk of deteriorating the heating element 10 and inducing the salting-out phenomenon. With the mechanisms as illustrated in FIGS. 11A to 11C provided upstream of the T-UFB generating unit 300, it is possible to remove the above-described impurities previously and to more efficiently generate a UFB-containing liquid with higher purity.

Particularly, in a case where an impurity removing unit using an ion-exchange resin illustrated in FIG. 11A is provided in the pre-processing unit, arrangement an anion-exchange resin contributes efficient generation of T-UFB water. This is because it has been confirmed that the ultra-fine bubbles generated by the T-UFB generating unit 300 have a negative charge. Accordingly, T-UFB water with high purity can be generated by removing the impurities having the same negative charges in the pre-processing unit. As the anion-exchange resin used herein, both the strongly basic anion-exchange resin having quaternary ammonium group and weakly basic anion-exchange resin having primary to tertiary amine group are appropriate. Which of these is appropriate depends on the type of the liquid to be used. Usually, in a case of using tap water, pure water, or the like as the liquid, the function of removing the impurities can be fulfilled sufficiently by using only the latter weakly basic anion-exchange resin.

### <<Liquid and Gas Usable for T-UFB-Containing Liquid>>

Now, the liquid W usable for generating the T-UFB-containing liquid is described. The liquid W usable in this embodiment is, for example, pure water, ion exchange water, distilled water, bioactive water, magnetic active water, lotion, tap water, sea water, river water, clean and sewage water, lake water, underground water, rain water, and so on. A mixed liquid containing the above liquid and the like is also usable. A mixed solvent containing water and soluble organic solvent can be also used. The soluble organic solvent to be used by being mixed with water is not particularly limited; however, the followings can be a specific example thereof. An alkyl alcohol group of the carbon number of 1 to 4 including methyl alcohol, ethyl alcohol, n-propyl alcohol, isopropyl alcohol, n-butyl alcohol, sec-butyl alcohol, and tert-butyl alcohol. An amide group including N-methyl-2-pyrrolidone, 2-pyrrolidone, 1,3-dimethyl-2-imidazolidinone, N,N-dimethylformamide, and N,N-dimethylacetamide. A keton group or a ketoalcohol group including acetone and diacetone alcohol. A cyclic ether group including tetrahydrofuran and dioxane. A glycol group including ethylene glycol, 1,2-propylene glycol, 1,3-propylene glycol, 1,2-butanediol, 1,3-butanediol, 1,4-butanediol, 1,5-pentanediol, 1,2-hexanediol, 1,6-hexanediol, 3-methyl-1,5-pentanediol, diethylene glycol, triethylene glycol, and thiodiglycol. A group of lower alkyl ether of polyhydric alcohol including ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, and triethylene glycol monobutyl ether. A polyalkylene glycol group including polyethylene glycol and polypropylene glycol. A triol group including glycerin, 1,2,6-hexanetriol, and trimethylolpropane.

These soluble organic solvents can be used individually, or two or more of them can be used together.

A gas component that can be introduced into the dissolving unit 200 is, for example, hydrogen, helium, oxygen, nitrogen, methane, fluorine, neon, carbon dioxide, ozone, argon, chlorine, ethane, propane, air, and so on. The gas component may be a mixed gas containing some of the above. Additionally, it is not necessary for the dissolving unit 200 to dissolve a substance in a gas state, and the dissolving unit 200 may fuse a liquid or a solid containing desired components into the liquid W. The dissolution in this case may be spontaneous dissolution, dissolution caused by pressure application, or dissolution caused by hydration, ionization, and chemical reaction due to electrolytic dissociation.

### <<Specific Example of Case of Using Ozone Gas>>

Here, as a specific example, a case of using ozone gas as the gas component is described. First, a method of generating ozone gas may include an electric discharge method, an electrolytic method, and an ultraviolet lamp method. The above methods are described below in sequence.

### (1) Electric Discharge Method

The electric discharge method includes a silent electric discharge method and a surface electric discharge method. In the silent electric discharge method, an alternating-current high voltage is applied while an oxygen-containing gas is flowed between a pair of electrodes arranged in the form of parallel flat plates or coaxial cylinders. With this, discharge occurs in the oxygen-containing gas, and ozone gas is generated. One of or both the surfaces of the pair of electrodes need to be covered with a dielectric such as glass. The discharge occurs in a gas (air or oxygen) in association with charges on the surface of the dielectric alternately varied positively and negatively.

On the other hand, in the surface electric discharge method, a surface of a flat plate-shaped electrode is covered with a dielectric such as ceramics, and a linear electrode is arranged on the surface of the dielectric. Then, an alternating-current high voltage is applied between the flat plate-shaped electrode and the linear electrode. With this, discharge occurs on the surface of the dielectric, and ozone gas is generated.

### (2) Electrolytic Method

A pair of electrodes with an electrolyte membrane arranged therebetween are arranged in water, and a direct-current voltage is applied between the two electrodes. With this, electrolysis of the water occurs, and ozone gas is generated with oxygen on the oxygen generation side. An ozone generator being practically used includes porous titanium having a platinum catalyst layer on a cathode, porous titanium having a lead dioxide catalyst layer on an anode, one using a perfluorosulfonic acid cation exchange membrane as an electrolyte membrane, and the like. According to the present apparatus, highly concentrated ozone of 20% by weight or greater can be generated.

### (3) Ultraviolet Lamp Method

Ozone gas is generated by exposing ultraviolet to the air and the like by using a similar principle as that of how the ozone layer of Earth is created. Usually, a mercury lamp is used as an ultraviolet lamp.

In a case of using ozone gas as the gas component, an ozone gas generating unit employing the methods (1) to (3) described above may be additionally added to the UFB generating apparatus 1 in FIG. 1.

Next, a method of dissolving the generated ozone gas is described. A method appropriate for dissolving ozone gas into the liquid W may include an “air bubble dissolution method”, a “membrane contactor dissolution method”, and a “filled-layer dissolution method” in addition to the pressurized dissolution method illustrated in FIGS. 3A and 3B. Hereinafter, the above three methods are compared with each other and described in sequence.

### (i) Air Bubble Dissolution Method

This is a method of mixing ozone gas into the liquid W as bubbles and flowing the ozone gas with the liquid W to dissolve. For example, there are a bubbling method in which ozone gas is blown from a lower portion of a container retaining the liquid W, an ejector method in which a narrow portion is provided in a part of a pipe through which the liquid W flows and ozone gas is blown into the narrow portion, a method of agitating the liquid W and the ozone gas by a pump, and the like. The air bubble dissolution method is a comparatively compact dissolution method and is used in a water treatment plant and the like.

### (ii) Membrane Contactor Dissolution Method

This is a method of absorbing and dissolving ozone gas into the liquid W by flowing the liquid W through a porous Teflon (registered trademark) membrane while the ozone gas is flowed through the outside.

(iii) Filled-Layer Dissolution Method

This is a method of dissolving ozone gas into the liquid W in a filled-layer by making counterflow of the ozone gas and the liquid by flowing the liquid W from the top of the filled-layer while flowing the ozone gas from the bottom.

In a case of employing the methods (i) to (iii) described above, the dissolving unit 200 of the UFB generating apparatus 1 may be changed from the one with the configuration illustrated in FIGS. 3A and 3B to the one with the configuration employing any one of the methods (i) to (iii).

Particularly, in terms of the severe toxicity, ozone gas with high purity is obligated to purchase with a gas cylinder and the usage is limited unless a special environment is prepared. For this reason, it is difficult to generate ozone microbubbles and ozone ultra-fine bubbles by conventional methods of generating microbubbles or ultra-fine bubbles by gas introduction (for example, a Venturi method, a swirl flow method, a pressurized dissolution method, and so on).

On the other hand, as a method of generating ozone dissolving water, a method of generating ozone from oxygen supplied by the above-described electric discharge method, electrolytic method, or ultraviolet lamp method and dissolving into the water concurrently with the ozone generation is useful from the points of the safety and the handleability.

However, in a case of employing a cavitation method and the like, although it is possible to generate ozone ultra-fine bubbles by using the ozone dissolving water, there are still problems such as an increase in size of the apparatus and the difficulty in increasing the concentration of the ozone ultra-fine bubbles.

In contrast, the T-UFB generating method of the present embodiment is better than the other generating methods such as the cavitation method in that the apparatus can be proportionally small in size, and highly concentrated ozone ultra-fine bubbles can be generated from the ozone dissolving water.

### <<Effects of T-UFB Generating Method>>

Next, the characteristics and the effects of the above-described T-UFB generating method are described by comparing with a conventional UFB generating method. For example, in a conventional air bubble generating apparatus as represented by the Venturi method, a mechanical depressurizing structure such as a depressurizing nozzle is provided in a part of a flow passage. A liquid flows at a predetermined pressure to pass through the depressurizing structure, and air bubbles of various sizes are generated in a downstream region of the depressurizing structure.

In this case, among the generated air bubbles, since the relatively large bubbles such as milli-bubbles and microbubbles are affected by the buoyancy, such bubbles rise to the liquid surface and disappear. Even the UFBs that are not affected by the buoyancy may also disappear with the milli-bubbles and microbubbles since the gas-liquid interface energy of the UFBs is not very large. Additionally, even if the above-described depressurizing structures are arranged in series, and the same liquid flows through the depressurizing structures repeatedly, it is impossible to store for a long time the UFBs of the number corresponding to the number of repetitions. In other words, it has been difficult for the UFB-containing liquid generated by the conventional UFB generating method to maintain the concentration of the contained UFBs at a predetermined value for a long time.

In contrast, in the T-UFB generating method of this embodiment utilizing the film boiling, a rapid temperature change from normal temperature to about 300° C. and a rapid pressure change from normal pressure to around a several megapascal occur locally in a part extremely close to the heating element. The heating element is a rectangular shape having one side of around several tens to hundreds of μm. It is around 1/10 to 1/1000 of the size of a conventional UFB generating unit. Additionally, with the gas-dissolved liquid within the extremely thin film region of the film boiling bubble surface exceeding the thermal dissolution limit or the pressure dissolution limit instantaneously (in an extremely short time under microseconds), the phase transition occurs and the gas-dissolved liquid is precipitated as the UFBs. In this case, the relatively large bubbles such as milli-bubbles and microbubbles are hardly generated, and the liquid contains the UFBs of about 100 nm in diameter with extremely high purity. Moreover, since the T-UFBs generated in this way have sufficiently large gas-liquid interface energy, the T-UFBs are not broken easily under the normal environment and can be stored for a long time.

Particularly, the present invention using the film boiling phenomenon that enables local formation of a gas interface in the liquid can form an interface in a part of the liquid close to the heating element without affecting the entire liquid region, and a region on which the thermal and pressure actions performed can be extremely local. As a result, it is possible to stably generate desired UFBs. With further more conditions for generating the UFBs applied to the generation liquid through the liquid circulation, it is possible to additionally generate new UFBs with small effects on the already-made UFBs. As a result, it is possible to produce a UFB liquid of a desired size and concentration relatively easily.

Moreover, since the T-UFB generating method has the above-described hysteresis properties, it is possible to increase the concentration to a desired concentration while keeping the high purity. In other words, according to the T-UFB generating method, it is possible to efficiently generate a long-time storable UFB-containing liquid with high purity and high concentration.

The method of dissolving ozone gas into the liquid W is described herein; however, a method of dissolving nitric oxide gas into the liquid W instead of ozone gas may be applied. Use of nitric oxide gas is also appropriate for medical and clinical application by using a biological activity function and the like.

### <Manufacturing Apparatus for Solidified Matter of UFB-Containing Liquid>

Next, a manufacturing apparatus for a solidified matter of a UFB-containing liquid of the present disclosure is described with reference to the drawings. Parts of the manufacturing apparatus for the solidified matter of the UFB-containing liquid described below that are the same as or comparable to that of the above-described UFB generating apparatus 1 are marked with the same signs, and duplicated descriptions are omitted.

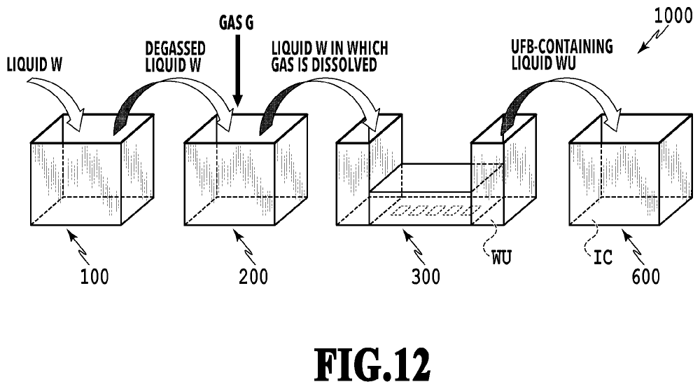

FIG. 12 is a diagram illustrating a basic conceptual configuration of a manufacturing apparatus 1000 for a solidified matter of a UFB-containing liquid of the present disclosure. The manufacturing apparatus 1000 for the solidified matter of the UFB-containing liquid (hereinafter, also referred to as simply a solidified matter manufacturing apparatus) includes a freezing unit 600 in addition to the above-described pre-processing unit 100, dissolving unit 200, and T-UFB generating unit 300. The processing unique to each unit is performed in the above-described order on the liquid W such as water (purified water) supplied to the pre-processing unit 100, and a solidified matter (ice) created by freezing and solidifying the T-UFB-containing liquid is collected from the freezing unit 600. First to sixth embodiments of the manufacturing apparatus for the solidified matter of the UFB-containing liquid of the present disclosure are described below. In the following descriptions, the T-UFB generating unit 300 is simply referred to as a UFB generating unit 300, and the T-UFB-containing liquid (or T-UFB-containing water) is simply referred to as a UFB-containing liquid (or UFB-containing water).

### First Embodiment

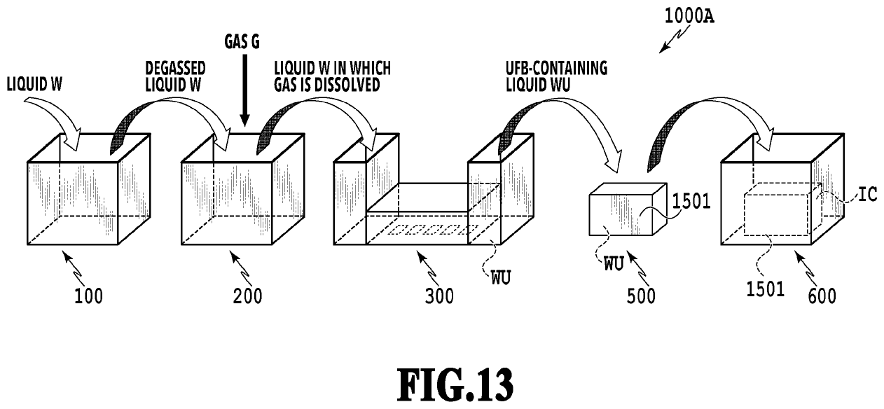

FIG. 13 is a diagram illustrating a conceptual configuration of a manufacturing apparatus 1000A for the solidified matter of the UFB-containing liquid in the present embodiment. The manufacturing apparatus 1000A for the solidified matter of the UFB-containing liquid includes a filling unit 500 between the UFB generating unit (ultra-fine bubble generating unit) 300 and the freezing unit 600 (cooling unit) in the basic solidified matter manufacturing apparatus 1000 illustrated in FIG. 12. The filling unit 500 fills a container 1501 with a UFB-containing liquid WU obtained from the UFB generating unit 300. Thereafter, the container 1501 filled with the UFB-containing liquid WU is transferred to the freezing unit 600. In the freezing unit 600, a solidified matter (ice) IC is manufactured by performing a slow freezing method in which the UFB-containing liquid is frozen and solidified while filling the container 1501 for 12 hours or more or 24 hours or more of time per liter. The configuration and function of each unit are described below in more detail.

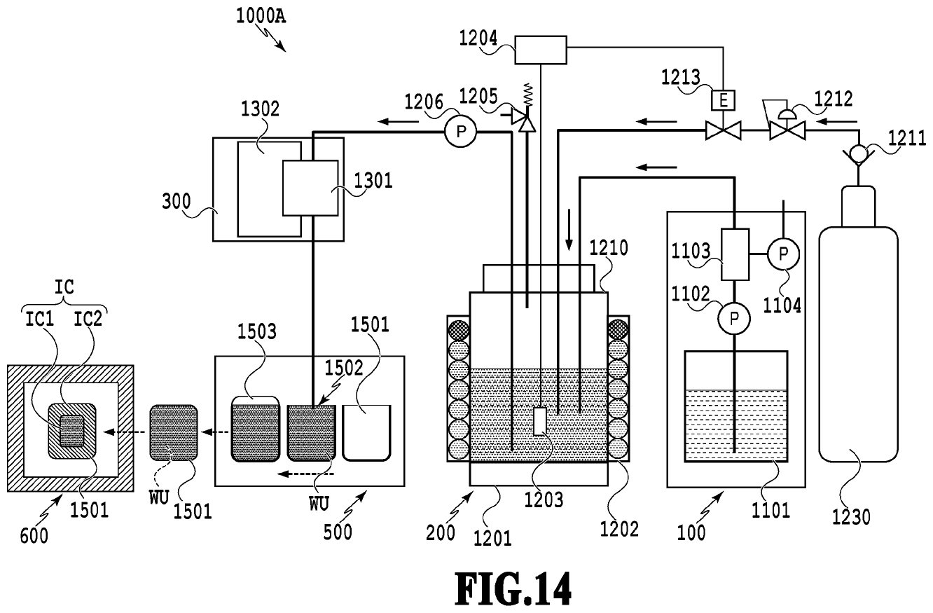

FIG. 14 is a diagram illustrating in more detail a configuration of the manufacturing apparatus 1000A for the solidified matter of the UFB-containing liquid in the present embodiment. Here is described an example in which pure water is used as the liquid used to generate the UFB-containing liquid WU, and nitrogen gas is used as the gas to be dissolved into the liquid (pure water).

The pure water is retained in a solution tank 1101. The pure water is sucked up from the solution tank 1101 by a pump 1102 and transferred to a degassing module 1103. In the degassing module 1103, a gas such as the air dissolved in the pure water is removed under reduced pressure by a degassing pump 1104, and thereafter the pure water is transferred to the dissolving unit 200. The dissolving unit 200 is provided with a gas dissolving tank 1210 for dissolving a gas (nitrogen gas) into the pure water transferred from the degassing module 1103. The inside of the gas dissolving tank 1210 is filled in advance with nitrogen gas that is transferred from a nitrogen gas cylinder 1230 through a flow regulating valve 1212 and an electromagnetic open-close valve 1213. In the gas dissolving tank 1210, the nitrogen gas filling the inside is dissolved into the pure water transferred from the degassing module 1103. A method of dissolving the nitrogen gas includes methods such as the pressurized dissolution method and bubbling and also, for example, a method of agitating by a gas dissolution facilitating mechanism 1201 using a magnetic stirrer, ultrasonic waves, and the like. With such a dissolution method, the nitrogen gas is dissolved into the pure water in the gas dissolving tank 1210 to reach the saturation solubility. In this process, it is possible to generate a liquid in which the highly concentrated nitrogen gas is dissolved in a shorter time by cooling the pure water in the gas dissolving tank 1210. For this reason, in the present embodiment, an outer wall of the gas dissolving tank 1210 is surrounded by a cooling jacket 1202 flowing cooling water, and the liquid (pure water) is cooled by cooling the gas dissolving tank 1210 by the cooling jacket 1202. In addition to the method of cooling the gas dissolving tank 1210 from the outside as described above, it is also possible to employ a method of arranging a corrugated tube through which a refrigerant passes in the gas dissolving tank 1210 as a method of cooling the liquid in the gas dissolving tank 1210.

A concentration sensor 1203 that detects the concentration of the gas is provided in the gas dissolving tank 1210. The nitrogen gas is dissolved into the pure water by the gas dissolution facilitating mechanism 1201 while supplying the nitrogen gas until the concentration of the nitrogen gas contained in the nitrogen gas dissolving water measured by the concentration sensor 1203 reaches a state close to the saturation or reaches the saturation state. In this process, in order to prevent the pressure in the gas dissolving tank 1210 from exceeding a pressure resistance, excess nitrogen gas is discharged from a safety valve 1205. With this, the pressure in the gas dissolving tank 1210 is maintained at a constant pressure. The nitrogen gas dissolving water that reaches a desired gas dissolving concentration (in a case of nitrogen gas, saturation solubility of 0.0231 mL/mL) is supplied to a UFB generating head 1301 of the UFB generating unit 300 by a UFB generating head transfer pump 1206.

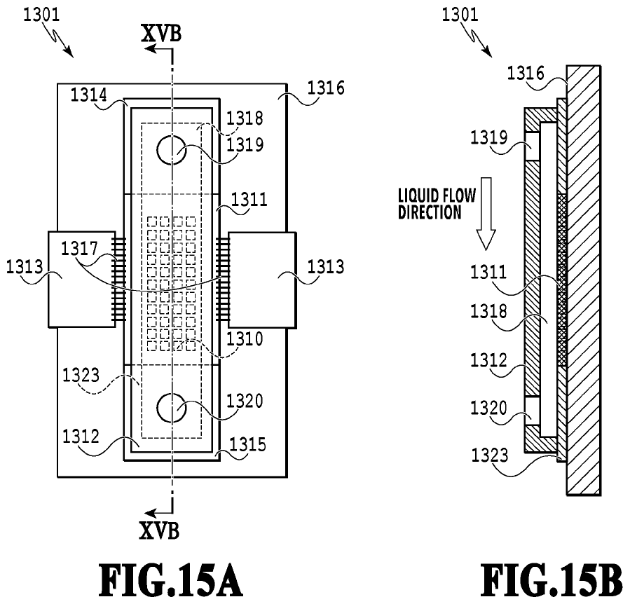

In the UFB generating head 1301, the nitrogen gas dissolving water is heated by heating elements (heaters) aligned therein to make film boiling in the nitrogen gas dissolving water and generate UFBs of the nitrogen gas, and thus the UFB-containing water (UFB-containing liquid) WU is generated. Driving of the heating elements in the UFB generating head 1301 in this process is controlled by a driving control system 1302. The configuration of the UFB generating head 1301 is described later in more detail with reference to FIGS. 15A to 17B.

The UFB-containing water WU containing the UFBs of the nitrogen gas generated by the UFB generating unit 300 is transferred to the filling unit 500. After the filling unit 500 fills the container 1501 with a certain amount of the UFB-containing water WU in a UFB encapsulating unit 1502, an opening formed at the top of the container 1501 is sealed by a lid 1503. Thereafter, the container 1501 is transferred to the freezing unit 600.

The freezing unit 600 cools the container 1501 and slowly freezes and solidifies the UFB-containing water WU stored therein for a predetermined time (for example, 12 hours or more, preferably 24 hours or more). With this, the solidified matter (ice) IC of the UFB-containing water WU is manufactured. Details of the method of freezing the UFB-containing water in the freezing unit 600 are described later.

In the above-described filling unit 500, it is favorable for the container 1501 filled with the UFB-containing water WU and the lid 1503 to satisfy conditions such as light weight, impact-resistant, and significantly low gas permeability. For this reason, in the present embodiment, multiple layers of films are used as a material forming the container 1501. As the multiple layers of films, for example, a film having stretchability in which resin is laminated on a base material such as a bi-axially oriented polyamide film (manufactured by Mitsubishi Chemical Corporation; SUPERNYL (registered trademark)) and ethylene vinyl alcohol copolymer (manufactured by Kuraray Co., Ltd.; EVAL (registered trademark)) is used. After the container 1501 formed of such a material is filled with the UFB-containing water, the lid 1503 is thermally compressed to seal the opening so as not to be exposed. Favorably, the lid 1503 is formed such that the volume expansion due to the freezing can be absorbed by changing forms of the container 1501 and the lid 1503 during the freezing and solidifying of the UFB-containing liquid WU in the freezing unit 600.

### <UFB Generating Head>

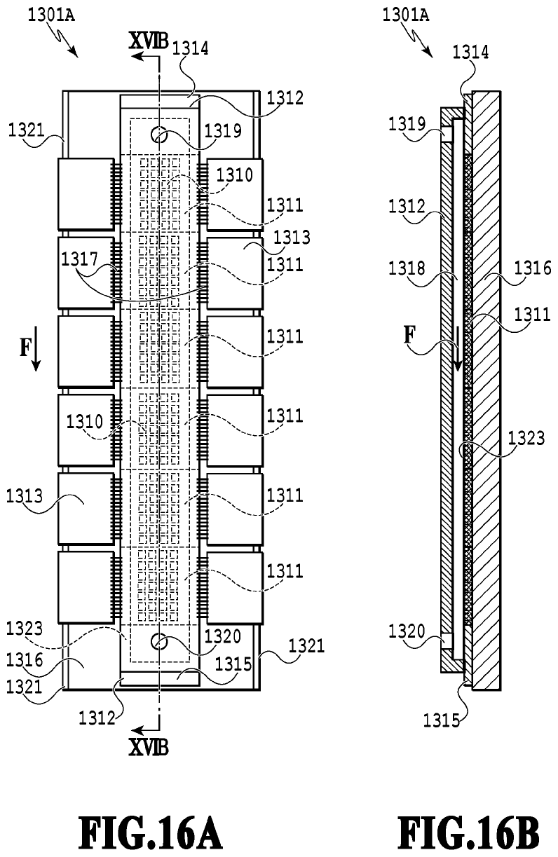

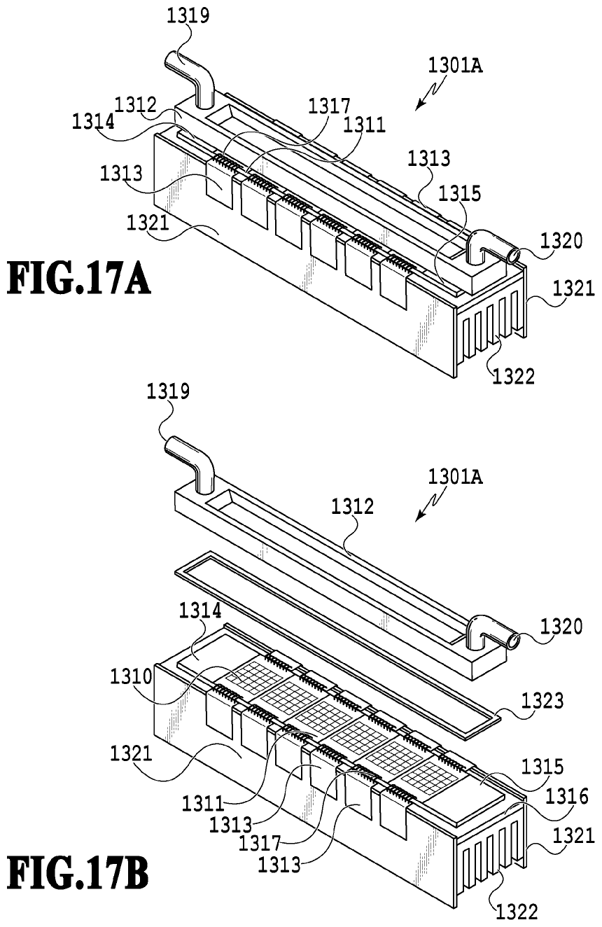

Here, the UFB generating head 1301 is described in more detail with reference to FIGS. 15A, 15B, 16A, 16B, 17A, and 17B. FIGS. 15A and 15B are diagrams illustrating a basic configuration of the UFB generating head 1301, while FIG. 15A is a plan view, and FIG. 15B is a cross-sectional view of FIG. 15A taken along line XVB-XVB. FIGS. 16A and 16B are a plan view and a cross-sectional view illustrating a UFB generating head 1301A having another configuration, while FIG. 16A is a plan view, and FIG. 16B is a cross-sectional view of FIG. 16A taken along line XVIB-XVIB. FIGS. 17A and 17B are diagrams illustrating the UFB generating head 1301A illustrated in FIG. 16A, while FIG. 17A is a perspective view, and FIG. 17B is an exploded perspective view.

As illustrated in FIGS. 15A and 15B, the UFB generating head 1301 includes an element substrate 1311, a support substrate 1316 supporting the element substrate 1311, and a flow passage member 1312 attached on the element substrate 1311 via a frame 1323. On the element substrate 1311, multiple energy generating elements (heating elements) 1310 that generate heat energy are arranged. The element substrate 1311 is connected to a wiring substrate 1313 via a bonding wire 1317. The wiring substrate 1313 is connected to a control unit not illustrated. As illustrated in FIG. 15B, a liquid flow passage 1318 is formed between the element substrate 1311 and the flow passage member 1312. A liquid inlet port 1319 and a liquid outlet port 1320 are formed in the flow passage member 1312. The liquid inlet port 1319 communicates with the UFB generating head transfer pump 1206 (FIG. 14), while the liquid outlet port 1320 communicates with the UFB encapsulating unit 1502 of the filling unit 500.

The nitrogen gas dissolving water transferred from the dissolving unit 200 by the UFB generating head transfer pump 1206 illustrated in FIG. 14 flows into the liquid flow passage 1318 of the UFB generating head 1301 from the liquid inlet port 1319 illustrated in FIGS. 15A and 15B. Once the liquid flow passage 1318 is filled with the nitrogen gas dissolving water, the heating elements 1310 are driven in response to a driving signal from the driving control system 1302. With the driving of the heating elements 1310, bubbling and bubble disappearance are repeated several thousand times every second in the nitrogen gas dissolving water. With this, an enormous amount of UFBs are generated in the nitrogen gas dissolving water, and a UFB-containing liquid with high purity is generated. The UFB-containing liquid is discharged from the liquid outlet port 1320 provided downstream of the element substrate 1311 and transferred to the UFB encapsulating unit 1502 of the filling unit 500 illustrated in FIG. 14.

FIGS. 15A and 15B exemplify a case of providing one element substrate 1311; however, depending on the amount of UFBs to be generated, a UFB generating head 1301A provided with multiple element substrates 1311 as illustrated in FIGS. 16A, 16B, 17A, and 17B may be used. The configuration and the manufacturing steps of the UFB generating head 1301A are specifically described with reference to FIGS. 16A, 16B, 17A, and 17B. In FIGS. 16A, 16B, 17A, and 17B, parts that are the same as or comparable to the configuration illustrated in FIGS. 15A and 15B are marked with the same signs.

Since the element substrate 1311 is formed through semiconductor manufacturing steps, in general, the element substrate 1311 is formed on a silicon substrate (not illustrated) of 6 to 12 inches (15.24 to 30.48 centimeters). In the present embodiment, multiple element substrates are formed by forming 60 pieces of element substrates of 22 mm×17 mm in size on a silicon substrate of 8 inches (20.32 centimeters), and cutting and separating the silicon substrate by a dicing device. In the UFB generating head 1301A illustrated in FIGS. 16A to 17B, six pieces of the element substrates 1311 are arranged and adhered in series sequentially on the support substrate 1316 made of alumina along a direction F of a liquid flow Thereafter, the flexible wiring substrate 1313 arranged on each of two sides of each element substrate 1311 is adhered and fixed to the support substrate 1316. Here, a gold wire of 25 micron in diameter is used as the bonding wire 1317, and the wiring substrate 1313 and the element substrate 1311 are connected to each other by wire bonding.

Next, the flow passage member 1312 made of stainless-steel (SUS316) in which the liquid inlet port 1319 and the liquid outlet port 1320 are formed is assembled on the heating elements 1310 on six pieces of the element substrates 1311 via the frame 1323 made of PTFE of 0.05 mm in thickness. Then, a not-illustrated ambient temperature curing type silicone sealant (manufactured by Momentive Performance Materials Japan LLC; TSE399) is applied along outer peripheries of the flow passage member 1312 and the frame 1323 to fix the flow passage member 1312 and the frame 1323 on the support substrate 1316. In the present embodiment, silicon substrates 1314 and 1315 having the same height as a surface of the element substrate 1311 are fixed in advance as a height adjustment substrate near an end portion on the upstream side and near an end portion on the down stream side of the support substrate 1316. With this, since the liquid (nitrogen gas dissolving water) flows along the surfaces at a uniform height in the liquid flow passage 1318, it is possible to smoothly flow the liquid. Additionally, on a back side of the support substrate 1316, a heatsink 1322 made of aluminum to release the heat generated from the heating elements 1310 is attached with a thermally conductive adhesive. For the cooling, other than the heatsink 1322 illustrated in FIGS. 17A and 17B, a Peltier element, a water-cooling member, and the like may be used. Note that, 1321 in the drawings indicates an integrated substrate arranged on the two sides of the support substrate 1316, and the integrated substrate 1321 is electrically connected to the wiring substrate 1313. The driving control signal transmitted from the not-illustrated control unit is inputted to each element substrate 1311 through the integrated substrate 1321, the wiring substrate 1313, and the bonding wire 1317, and the heating elements 1310 are driven.

On the UFB generating head 1301A illustrated in FIGS. 16A, 16B, 17A, and 17B, six pieces of the element substrates 1311 of 22 mm×17 mm on which 12,288 pieces of the heating elements (heat energy heating elements) 1310 are arranged are aligned in series, and a total of 73,728 heating elements 1310 are aligned. With each heating element 1310 driven at a driving frequency of 7.5 KHz, it is possible to generate every minute 180 to 200 mL of UFB-containing water containing about one billion UFBs per mL (milliliter).

### <Frozen UFB>

In a case of rapidly freezing a UFB-containing liquid, the speed of generating crystals of the water and the speed of freezing a portion in which UFBs exist are close, and a rapid pressure is applied to the UFBs. For this reason, there is a risk of deformation and disappearance of the UFBs, and there may occur a problem that the function of the original UFB-containing liquid cannot be reproduced after thawing. In contrast, the freezing unit 600 of the present embodiment employs the slow freezing method in which the freezing is performed slowly over time at a temperature range of a general freezer (−10° C. to −20° C.). This makes it possible to manufacture a solidified matter (ice) of a UFB-containing water with high clarity.

That is, with the UFB-containing water frozen by the slow freezing method, the water contained in the UFB-containing water is frozen first, and the UFBs as impurities in the water are assembled to a substantially central region. Thereafter, a portion with a high UFB-containing concentration (hereinafter, also referred to as a UFB high concentration solidified portion) assembled to the central region is also frozen slowly. Therefore, the deformation, disappearance, and the like of the UFBs during the rapid freezing of the UFB-containing liquid can be significantly reduced, and it is possible to generate the solidified matter (ice) of the UFB-containing liquid including a portion at a high UFB concentration (ultra-fine bubble concentration). The freezing speed is set to a speed at which the UFB-containing water stored in the container 1501 of one L (liter) with a side length of 10 cm is frozen by spending 12 to 24 hours at the above-described temperature range (−10° C. to −20° C.). In a case of freezing a UFB-containing water at such a slow freezing speed, the clarity of the liquid close to an inner peripheral surface of the container 1501 is high, and it is possible to obtain a solidified matter with a visible light transmittance of 70% or more. With the solidified matter of the UFB-containing liquid irradiated with a green laser, the green laser scatters in a substantially central region of the solidified matter; accordingly, it can be confirmed that there is a high concentration solidified portion in this region.

During the freezing and solidifying of the UFB-containing water, if the container 1501 is open to the outside like a case where no lid 1503 of the container 1501 is provided, the UFBs and a precipitate of the dissolved gas (in the present embodiment, nitrogen gas) may be pushed and released outward from the open portion. In this case, the UFB concentration may be decreased at the time of thawing the solidified matter to use. In order to avoid the release of the gas during the freezing as described above, it is favorable to keep the container 1501 used during the freezing to be in a sealed state. However, since a volume expansion occurs during the freezing of the UFB-containing water in the container 1501, it is favorable to use the container 1501 that is deformable in accordance with the volume expansion. The container 1501 used in the present embodiment is formed of a film and the like having stretchability as described above; for this reason, the sealed state can be maintained while dealing with the volume expansion during the freezing of the UFB-containing water. Additionally, the shape of the container 1501 is favorably centrally symmetric in order to assemble the high concentration solidified portion to a more central portion of the solidified matter of the UFB-containing liquid.

As described above, according to the present embodiment, it is possible to manufacture a solidified matter of a UFB-containing liquid while suppressing the disappearance, the change in function, and the like of the UFBs. Additionally, with the UFB-containing water changed into a solidified matter, it is possible to store the UFB-containing water while keeping the quality of the UFBs for long periods. Moreover, it is possible to easily transport the solidified matter by frozen transportation, and also the change in physical property of the UFBs caused by vibrations during the transportation can be suppressed. Accordingly, it is possible to provide an end user with UFBs in the form of a solidified matter while keeping the as-manufactured quality of the UFBs. The user is able to dissolve the solidified matter (ice) containing the UFBs to use as a UFB-containing liquid, and it is possible to use in the state of the solidified matter.

### Second Embodiment

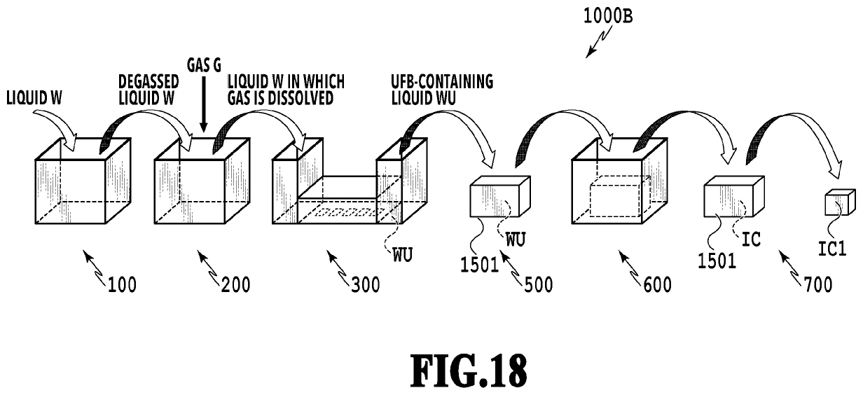

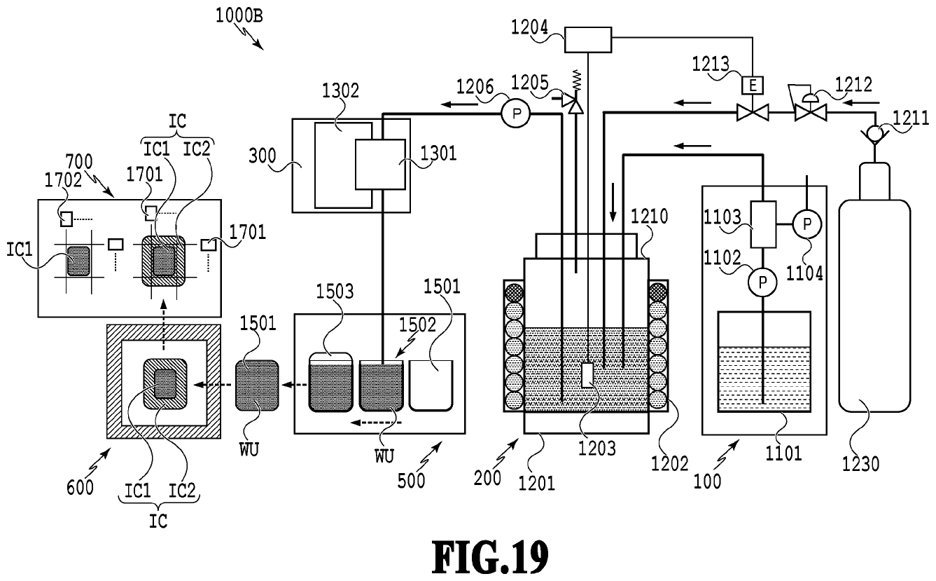

Next, an embodiment of the present disclosure is described with reference to FIGS. 18 and 19. FIG. 18 is a diagram illustrating a conceptual configuration of a manufacturing apparatus 1000B for the solidified matter of the UFB-containing liquid in a second embodiment. FIG. 19 is a diagram illustrating a detailed configuration of the manufacturing apparatus 1000B for the solidified matter of the UFB-containing liquid illustrated in FIG. 18. In FIGS. 18 and 19, parts that are the same as or comparable to the configuration illustrated in FIGS. 13 and 14 are marked with the same signs, and duplicated descriptions are omitted. Also in the present embodiment, here is described an example in which pure water is used as the liquid used to manufacture the UFB-containing liquid, and nitrogen gas is used as the gas to be dissolved into the liquid.

As illustrated in FIG. 18, the solidified matter manufacturing apparatus 1000B in the present embodiment manufactures the solidified matter (ice) IC of the UFB-containing liquid by freezing and solidifying the UFB-containing liquid by the slow freezing method in the freezing unit 600. This point is similar to the above-described embodiment. However, the present embodiment includes a post-fabricating unit 700 in which a high concentration solidified portion (first solidified portion) IC1 at a high UFB concentration is selectively taken out from the solidified matter IC. Based on FIG. 19, a characteristic configuration of the manufacturing apparatus 1000B for the solidified matter of the UFB-containing liquid is described below.

Also in the manufacturing apparatus 1000B for the solidified matter of the UFB-containing liquid, the solidified matter IC is manufactured by freezing the UFB-containing liquid WU stored in the container 1501 by the slow freezing method. With this, the high concentration solidified portion IC1 at a high UFB concentration is formed in the central region of the solidified matter IC, and a low concentration solidified portion (second solidified portion) IC2 at a concentration lower than that of the high concentration solidified portion IC1 is formed around the high concentration solidified portion IC1.

The solidified matter IC frozen by the freezing unit 600 is transferred to the post-fabricating unit 700. In the post-fabricating unit 700, the solidified matter IC is taken out from the container 1501. Then, the solidified matter IC taken out is irradiated with the green laser for detecting ultra-fine bubbles outputted from a green laser emitter (first laser output unit) 1701. Since the green laser scatters once being emitted on the ultra-fine bubbles, it is possible to recognize the scattering by a not-illustrated image recognizing unit, and the recognized scattering portion is determined as a region in which the high concentration solidified portion IC1 exists. Thereafter, the high concentration solidified portion IC1 is taken out by cutting off the low concentration solidified portion IC2 formed around the high concentration solidified portion IC1 by a predetermined taking-out unit. It is also possible to execute the cutting-off of the low concentration solidified portion IC2 by machine processing. However, in a case of machine processing, there may be concerned a mix of foreign matter (contamination) and the like generated during the fabrication. For this reason, in the present embodiment, the low concentration solidified portion IC2 is cut off from the high concentration solidified portion IC1 by non-contact fabrication in which the solidified matter IC is irradiated with a carbon dioxide laser outputted from a carbon dioxide laser output unit (second laser output unit) 1702.

As described above, several hundred millions to billions of UFBs per mL are assembled in the high concentration solidified portion IC1 taken out from the solidified matter IC. Accordingly, use of the high concentration solidified portion IC1 makes it possible to use the excellent features of the UFBs. Additionally, it is possible to store the solidified matter formed of the high concentration solidified portion IC1 in a freezer for long periods, and moreover, the volume of the high concentration solidified portion IC1 is smaller than the volume of the solidified matter IC before being cut off. For this reason, it is possible to achieve space-saving of a storage region such as a freezer. Since the high concentration solidified portion IC1 has a high UFB concentration, it can be used at a concentration depending on the intended use by diluting to a desired concentration after the solidified matter IC is dissolved or by putting a cut solidified matter into a solvent to dissolve.

### Third Embodiment

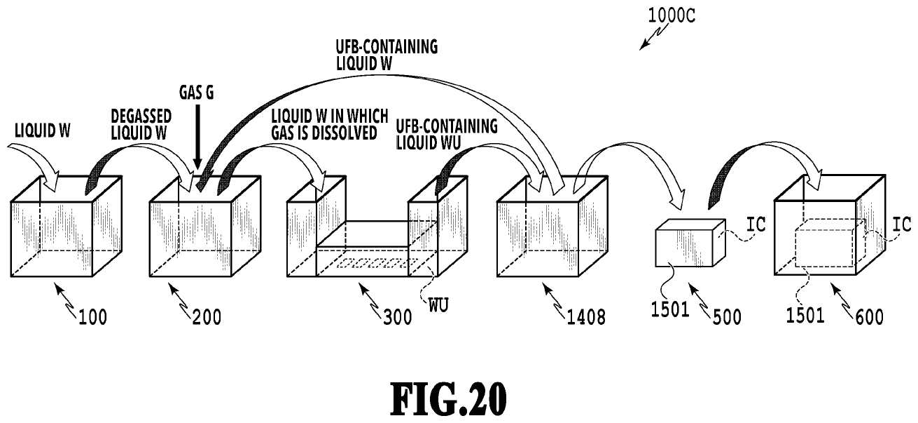

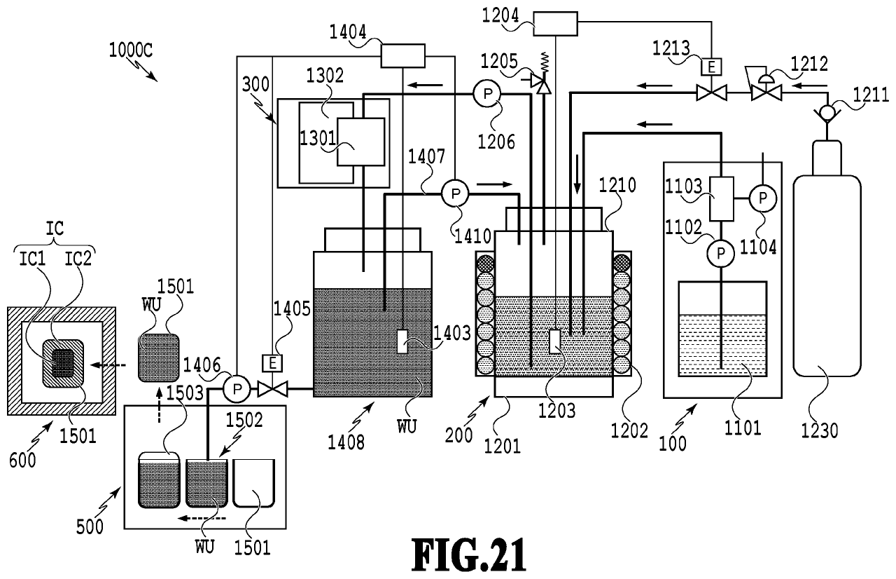

Next, a third embodiment of the present disclosure is described with reference to FIGS. 20 and 21. FIG. 20 is a diagram illustrating a conceptual configuration of a manufacturing apparatus 1000C for the solidified matter of the UFB-containing liquid in the third embodiment, while FIG. 21 is a diagram illustrating a detailed configuration of the manufacturing apparatus 1000C for the solidified matter of the UFB-containing liquid illustrated in FIG. 20. Also in the present embodiment, here is described an example in which pure water is used as the liquid used to manufacture the UFB-containing liquid, and nitrogen gas is used as the gas to be dissolved into the liquid.

As illustrated in FIG. 20, in the present embodiment, the UFB-containing liquid (UFB-containing water) WU containing the UFBs of nitrogen gas obtained from the UFB generating unit 300 is temporarily retained in a UFB retaining tank 1408. In this process, in a case of generating the UFB-containing liquid WU at a higher UFB concentration, the above-described UFB-containing liquid containing the UFBs may be supplied to the UFB generating unit 300 again. However, since the concentration of the nitrogen gas in the nitrogen gas dissolving water after the UFBs are generated is decreased, the amount of generated UFBs is lower than a case of initially generating the UFBs in the UFB generating unit 300.

To deal with this, in the present embodiment, there is formed a circulation route in which the UFB-containing water WU retained in the UFB retaining tank 1408 is temporarily put back to the dissolving unit 200 to raise the concentration to a desired nitrogen gas dissolving concentration, and thereafter, the UFB-containing water WU is supplied to the UFB generating unit 300 through a pipe 1407.

As illustrated in FIG. 21, the supplying of the UFB-containing water WU from the UFB retaining tank 1408 to the dissolving unit 200 is performed by a circulation pump 1410 connected to the pipe 1407. Thus, with the dissolving unit 200 added to the circulation route for circulating the UFB-containing water WU, the UFB concentration of the UFB-containing water WU can be proportionally increased every time the circulation is repeated. The UFBs are UFBs having a significantly stable shape with several ten to several hundred nanometers in diameter. For this reason, in a case where the UFB-containing water WU is circulated repeatedly while the amount of the gas dissolving water W to be supplied and the driving conditions of the UFB generating head 1301 are constant, the UFB concentration can be increased in substantially proportion to the number of times of the circulations and the driving time of the UFB generating head 1301 until reaching a certain UFB-containing concentration. Accordingly, the UFB-containing water WU at a desired UFB concentration (UFB-containing density) can be obtained by managing the UFB concentration of the UFB-containing water WU to be circulated.

In the present embodiment, in order to manage the UFB concentration of the UFB-containing water WU, a UFB concentration sensor 1403 is provided in the UFB retaining tank 1408 collecting the UFB-containing water WU. In accordance with the output from the UFB concentration sensor 1403, a UFB concentration controller 1404 checks the UFB concentration, and the UFB-containing water WU is circulated. Once the concentration of the circulated UFB-containing water WU reaches a desired UFB concentration, the UFB concentration controller 1404 stops the circulation of the UFB-containing water WU and the generation of the UFBs by the UFB generating head 1301. Then, the UFB concentration controller 1404 activates a pump 1406 while opening an open-close valve 1405 and transfers the UFB-containing liquid WU in the UFB retaining tank 1408 to the filling unit 500.

In this way, it is possible to efficiently generate the UFB-containing water WU at a desired UFB concentration. As a result of determining the UFB concentration based on light reflection by irradiating the UFB-containing water WU obtained as described above with the green laser, it is confirmed that the highly concentrated UFB-containing water WU is obtained by the method of circulating the UFB-containing water WU in the present embodiment.

In the present embodiment, here is described an example of using nitrogen gas as the gas to be dissolved into the liquid (pure water); however, the gas to be dissolved into the pure water is not limited thereto, and it is possible to use arbitrary gas. For example, hydrocarbon system gas such as hydrogen, helium, oxygen, methane, ethane, and propane, fluorine and fluorocarbon system gas, and gas selected from the group consisting of neon, carbon dioxide, ozone, argon, chlorine, and air can be dissolved into the liquid.

As with the above-described embodiment, the UFB-containing water WU reaching a desired UFB concentration fills the container 1501 in the filling unit 500 and is thereafter frozen and solidified by the slow freezing method in the freezing unit 600 to be the solidified matter (ice) IC. It is confirmed that the solidified matter IC manufactured by the slow freezing method has a visible light transmittance of 70% or more, and the high concentration solidified portion IC1 at a high UFB concentration and the low concentration solidified portion IC2 are formed therein. After thawing, a function comparable to that of the original UFB-containing liquid can be reproduced. The high concentration solidified portion IC1 of the solidified matter IC obtains a higher UFB concentration than the UFB concentration of the UFB-containing liquid before freezing.

### Fourth Embodiment

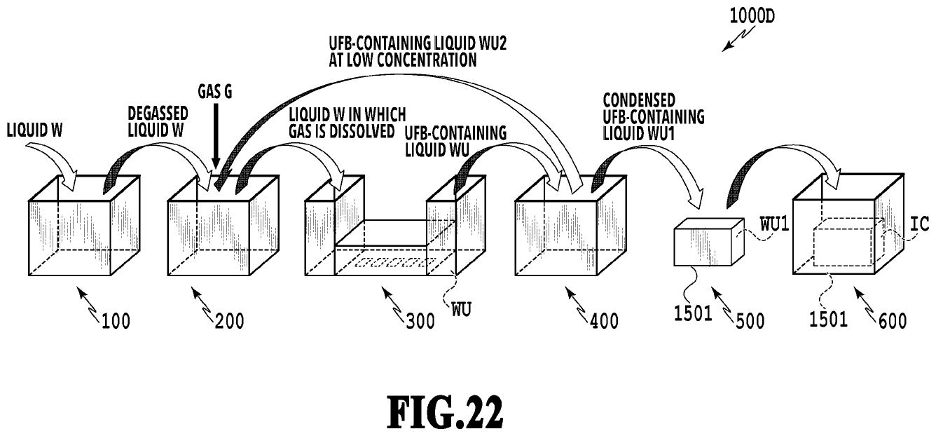

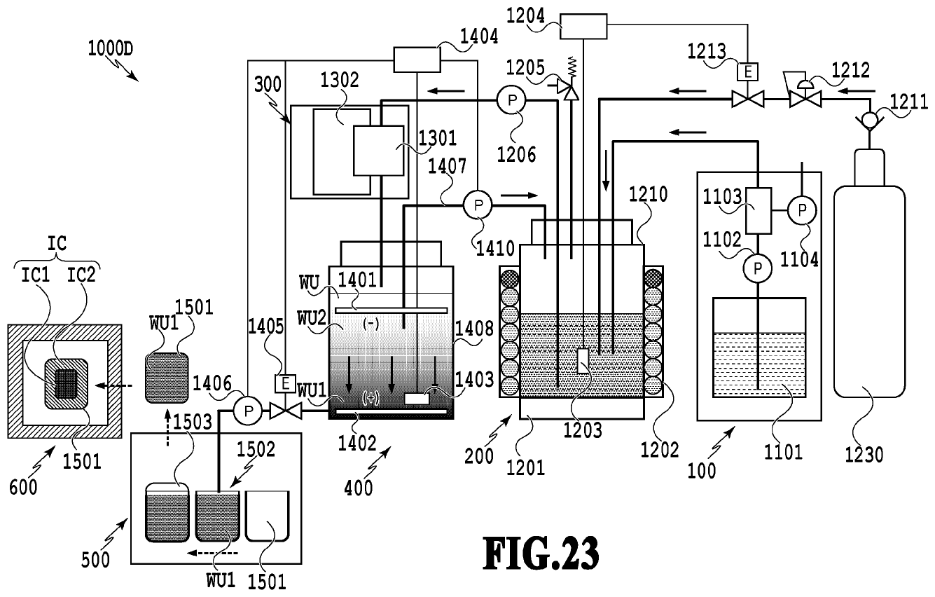

Next, a fourth embodiment of the present disclosure is described with reference to FIGS. 22 and 23. FIG. 22 is a diagram illustrating a conceptual configuration of a manufacturing apparatus 1000D for the solidified matter of the UFB-containing liquid in the fourth embodiment. FIG. 23 is a diagram illustrating a detailed configuration of the manufacturing apparatus 1000D for the solidified matter of the UFB-containing liquid illustrated in FIG. 22. Also in the present embodiment, here is described an example in which pure water is used as the liquid used to generate the UFB-containing liquid WU, and nitrogen gas is used as the gas to be dissolved into the liquid.

As illustrated in FIG. 22, in the present embodiment, the UFB-containing liquid (UFB-containing water) WU obtained from the UFB generating unit 300 is retained in the post-processing unit 400. In the post-processing unit 400, the UFB-containing water WU is divided into a condensed UFB-containing liquid WU1 condensed at a high UFB concentration and a UFB-containing water WU2 at a low concentration. Then, a series of circulation operations, in which the UFB-containing water WU2 at a low concentration is put back to the dissolving unit 200 again to dissolve a gas at a certain concentration therein, the UFBs are thereafter generated through the UFB generating unit 300, and the UFB-containing water WU at an increased UFB concentration is supplied to the post-processing unit 400 again, is repeated. On the other hand, the condensed UFB-containing liquid WU1 is transferred to the filling unit 500 to be stored in the container 1501 and is thereafter frozen by the slow freezing method in the freezing unit 600 to be the solidified matter IC.

The manufacturing apparatus 1000D for the solidified matter of the UFB-containing liquid of the present embodiment is described more specifically with reference to FIG. 23. The UFB-containing water WU containing the UFBs of nitrogen gas transferred from the UFB generating unit 300 is retained in the UFB retaining tank 1408 provided in the post-processing unit 400. In this process, in a case of generating the UFB-containing water WU at a higher UFB concentration, the UFB-containing water WU may be put back to the UFB generating unit 300 again from the UFB retaining tank 1408 to generate the UFBs; however, the gas dissolving concentration of the gas dissolving water after generating the UFBs is decreased. For this reason, during the circulation of the UFB-containing water WU in the UFB retaining tank 1408, the UFB-containing water WU is transferred to the dissolving unit 200 through the pipe 1407 to increase the dissolving amount of the nitrogen gas, and thereafter the UFBs are generated in the UFB generating unit 300. This makes it possible to increase the concentration of the UFBs to a certain concentration. However, once the UFBs reach a certain concentration by the circulation, there occurs a phenomenon that the existence of the already-generated UFBs reduce the efficiency of generating UFBs, and a rise in the UFB concentration suppressed. This may affect an instrument and drug discovery that require a highly concentrated UFB-containing liquid.

To deal with this, in order to obtain a UFB-containing liquid at a higher concentration, in the present embodiment, the UFB retaining tank 1408 includes a condensing unit that condenses the concentration of the UFBs. The condensing unit includes a UFB flow inhibiting unit that is provided in the UFB retaining tank 1408 and includes two UFB flow inhibiting units 1401 and 1402 inhibiting a flow of the UFBs. The flow inhibiting unit guides the UFBs to the UFB flow inhibiting unit 1402, which is one of the two UFB flow inhibiting units 1401 and 1402, to assemble the UFBs densely. With this, the condensed UFB-containing water WU1, which is condensed at a high UFB concentration, is generated around the one UFB flow inhibiting unit 1402. The condensed UFB-containing water WU1 is transferred to the following filling unit 500. Meanwhile, the UFB density is decreased around the UFBs of the other UFB flow inhibiting unit, and the UFB-containing water WU2 at a low UFB concentration is generated. After passing through the dissolving unit 200, the UFB-containing liquid WU2 at a low concentration is transferred to the UFB generating unit 300 to increase the UFB concentration and thereafter supplied to the UFB retaining tank 1408 again.

Here, the above-described UFB flow inhibiting units 1401 and 1402 are described in more detail. Out of the two UFB flow inhibiting units 1401 and 1402, the one UFB flow inhibiting unit 1401 includes a negative electrode and is arranged in an upper portion inside the UFB retaining tank 1408. The other UFB flow inhibiting unit 1402 includes a positive electrode and is arranged in a lower portion inside the UFB retaining tank 1408. A predetermined voltage is applied to the one UFB flow inhibiting unit 1401 and the other UFB flow inhibiting unit 1402, and a predetermined electric field is generated therebetween.

Since the UFBs are negatively charged, the UFBs contained in the UFB-containing water WU supplied to the UFB retaining tank 1408 are guided by electrophoresis to the UFB flow inhibiting unit 1402 arranged in the lower portion. That is, the UFB flow inhibiting unit 1401 arranged in the upper portion acts in a direction of pushing away the UFBs (downward), and the UFB flow inhibiting unit 1401 in the lower portion acts in a direction of drawing the UFBs. With this, in the UFB retaining tank 1408, the condensed UFB-containing water WU1, which is condensed at a high UFB concentration, is generated around the UFB flow inhibiting unit 1402 in the lower portion, while the UFB-containing water WU2 at a low concentration is generated around the UFB flow inhibiting unit 1401 in the upper portion. In the illustrated example, an example in which the UFB flow inhibiting units 1401 and 1402 are arranged inside the UFB retaining tank 1408 is described; however, as long as it is possible to generate the electric field to guide the UFBs, an electrode as the UFB flow inhibiting unit may be disposed on an outer surface of the UFB retaining tank 1408.

The UFB concentration sensor 1403 that detects the UFB concentration of the condensed UFB-containing water WU1, which is condensed by the UFB flow inhibiting units 1401 and 1402, is provided in the lower portion of the UFB retaining tank 1408. Once the UFB concentration sensor 1403 confirms that the condensed UFB-containing water WU1 reaches a desired concentration, the UFB concentration controller 1404 activates the pump 1406 and opens the open-close valve 1405. With this, the highly concentrated UFB-containing water is transferred to the filling unit 500 as a next processing step unit.

On the other hand, the UFB-containing water at a low UFB concentration existing around the UFB flow inhibiting unit 1401 including the negative electrode is transferred to the dissolving unit 200 through the pipe 1407. The dissolving unit 200 dissolves the gas (nitrogen gas) into the UFB-containing water WU at a low nitrogen gas dissolving concentration to increase the nitrogen gas solubility to reach a saturation state or substantially a saturation state and thereafter transfers the UFB-containing water to the UFB generating unit 300. After the UFB concentration is increased in the UFB generating unit 300, the UFB-containing water WU transferred to the UFB generating unit 300 is transferred to the UFB retaining tank 1408 again. The UFB-containing liquid WU transferred to the UFB retaining tank 1408 is guided to the side of the UFB flow inhibiting unit 1402 as the positive electrode and is assembled to a lower region of the UFB retaining tank 1408.

Thus, in the present embodiment, the UFB concentration of the UFB-containing liquid WU is increased by assembling the UFBs to a periphery of the UFB flow inhibiting unit 1402 including the positive electrode, and also the UFB-containing liquid WU2 at a low UFB concentration existing around the UFB flow inhibiting unit 1401 including the negative electrode is circulated. With this, the condensed UFB-containing water WU1 can be generated efficiently.

The condensed UFB-containing water WU1 is transferred to the filling unit 500 by the pump 1406 as described above. In the filling unit 500, the container 1501 is filled with a certain amount of the condensed UFB-containing water WU1, and after the container 1501 is sealed with the lid 1503 to prevent entering of a gas (air) into the container 1501, the UFB-containing water WU1 is transferred to the freezing unit 600. The condensed UFB-containing water WU1 transferred to the freezing unit 600 is frozen and solidified by the slow freezing method to be the solidified matter IC. The solidified matter IC has a high visible light transmittance and is the solidified matter IC in which the high concentration solidified portion IC1 at a high UFB concentration and the low concentration solidified portion IC2 at a low UFB concentration are formed. The high concentration solidified portion IC1 of the solidified matter IC obtains a higher UFB concentration than that of the condensed UFB-containing liquid WU1.

The UFB-containing liquid solidified matter IC manufactured as described above is a high quality solidified matter at a high concentration in which the disappearance and the change in function of the UFBs are suppressed, and the excellent features of the UFB-containing liquid can be reproduced even in a dissolved state. Additionally, the solidified matter IC is able to be stored while maintaining the quality for long periods in a freezer. Moreover, since it is possible to make frozen transportation while the UFB concentration is condensed, it is possible to achieve space-saving and weight-saving during the transportation, and the logistic cost can be suppressed.

### Fifth Embodiment

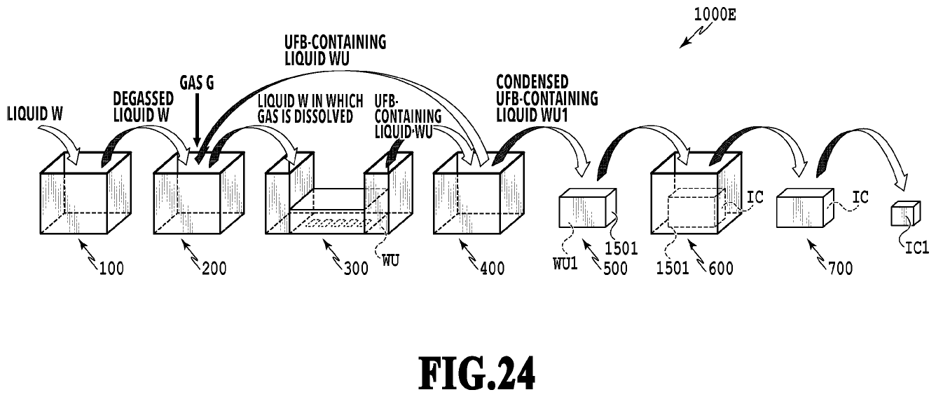

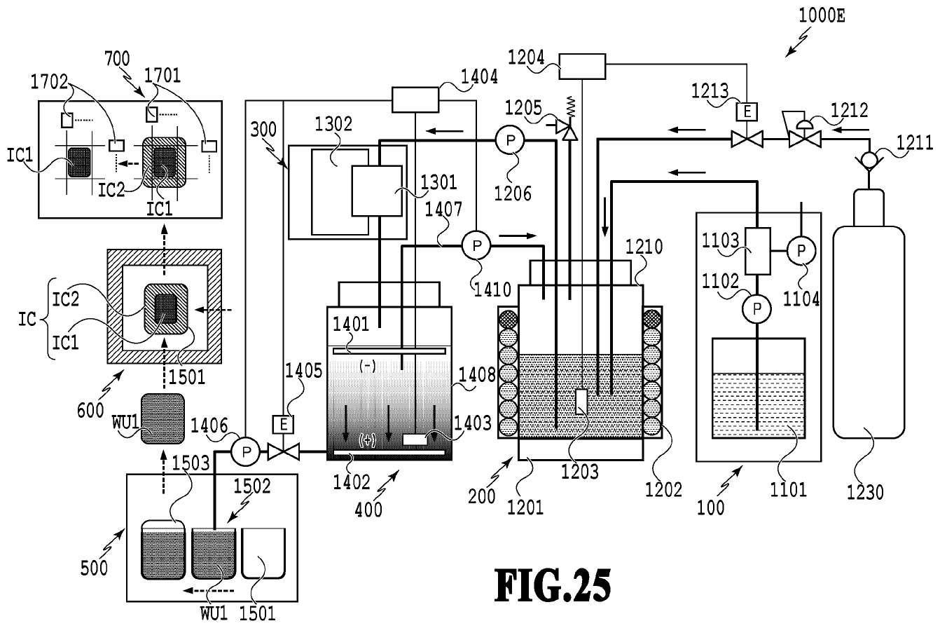

Next, a fifth embodiment of the present disclosure is described with reference to FIGS. 24 and 25. FIG. 24 is a diagram illustrating a conceptual configuration of a manufacturing apparatus 1000E for the solidified matter of the UFB-containing liquid in the fifth embodiment, while FIG. 25 is a diagram illustrating a detailed configuration of the manufacturing apparatus 1000E for the solidified matter of the UFB-containing liquid illustrated in FIG. 24. Also in the present embodiment, here is described an example in which pure water is used as the liquid used to manufacture the UFB-containing liquid, and nitrogen gas is used as the gas to be dissolved into the liquid.

As illustrated in FIG. 24, in addition to the configuration similar to that of the fourth embodiment, the solidified matter manufacturing apparatus 1000E in the present embodiment includes the post-fabricating unit 700 that takes out the high concentration solidified portion IC1 from the solidified matter IC. That is, the solidified matter IC of the condensed UFB-containing liquid WU1 is manufactured by freezing and solidifying the condensed UFB-containing liquid WU1 generated in the post-processing unit 400 by the slow freezing method in the freezing unit 600. Thereafter, in the post-fabricating unit 700, the high concentration solidified portion IC1 at a high UFB concentration is taken out from the solidified matter IC.

The high concentration solidified portion IC1 is recognized in the post-fabricating unit 700 illustrated in FIG. 25. In the post-fabricating unit 700, the solidified matter IC is irradiated with the green laser outputted from the green laser emitter 1701, and the region of the high concentration solidified portion IC1 as the UFB high concentration solidified portion is recognized as an image. Then, a portion other than the recognized high concentration solidified portion IC1 (portion other than the first solidified portion), that is, the low concentration solidified portion IC2 is cut off by the carbon dioxide laser outputted from the carbon dioxide laser output unit 1702, and the high concentration solidified portion IC1 is taken out.

According to the present embodiment, since the condensed UFB-containing water WU1, which is already sufficiently condensed before the freezing and solidifying, is frozen and solidified, the high concentration solidified portion IC1 of the solidified matter IC is increased to a UFB concentration of several billions per mL. Accordingly, with the high concentration solidified portion IC1 taken out selectively, it is possible to store an enormous amount of UFBs in a small space in a freezer for long periods. At the point of use, the high concentration solidified portion IC1 may be diluted at a desired concentration depending on the intended use, and it is possible to apply to various applications.

### Sixth Embodiment

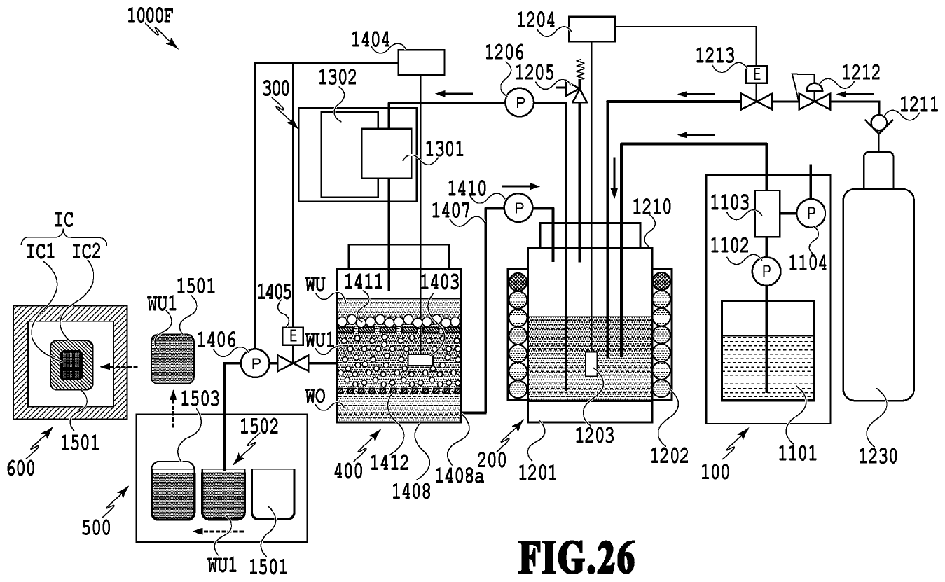

Next, a sixth embodiment of the present disclosure is described with reference to FIG. 26. FIG. 26 is a diagram illustrating a configuration of a manufacturing apparatus 1000F for the solidified matter of the UFB-containing liquid in the present embodiment. Also in the present embodiment, here is described an example in which pure water is used as the liquid used to manufacture the UFB-containing liquid, and nitrogen gas is used as the gas to be dissolved into the liquid.

In the above-described fourth and fifth embodiments, there is described an example of condensing the UFB-containing liquid by an electric method (electrophoresis) using the two UFB flow inhibiting units 1401 and 1402 as the condensing unit to condense the concentration of the UFBs in the UFB retaining tank 1408. In contrast, the condensing unit in the present embodiment condenses the UFB concentration of the UFB-containing water WU by physically inhibiting a flow of the UFBs by using a flow inhibiting unit including two UFB flow inhibiting units 1411 and 1412 that each include a filtration filter. Hereinafter, the UFB flow inhibiting unit 1411 is referred to as a first filter 1411, while the UFB flow inhibiting unit 1412 is referred to as a second filter 1412.

Also in the present embodiment, here is formed a circulation route in which the UFB-containing water WU retained in the UFB retaining tank 1408 is transferred to the dissolving unit 200 by the pump 1406 through the pipe 1407 and thereafter put back to the UFB retaining tank 1408 again by way of the UFB generating unit 300. In the UFB retaining tank 1408 forming a part of the circulation flow passage, the UFB-containing water WU supplied from the UFB generating unit 300 flows to a first outlet 1408a communicating with the pipe 1407. The first filter 1411 is arranged upstream in a flow direction of the UFB-containing liquid WU, while the second filter 1412 is arranged downstream of the first filter 1411.

The first filter 1411 includes a filtration filter of 1 μm in captured particle diameter. The first filter 1411 captures microbubbles of 1.0 μm or greater contained in the UFB-containing water flowing into the UFB retaining tank 1408. Since the UFBs have a particle diameter of smaller than 1.0 m, the UFBs pass through the first filter 1411.

The second filter 1412 includes a filtration filter of a smaller filtration particle size than that of the first filter 1411. Specifically, the second filter 1412 includes a filtration filter of a captured particle diameter of 0.1 μm. Therefore, the second filter 1412 captures the UFBs, and the liquid component (water) passes therethrough as filtrated water.

Filtrated water WO passing through the second filter 1412 returns to the dissolving unit 200 and is supplied to the UFB generating unit 300 as gas dissolving water at a certain gas dissolving concentration (nitrogen gas solubility). After the water becomes the UFB-containing liquid WU in this process, the UFB-containing liquid WU flows into the UFB retaining tank 1408 again.

On the other hand, in a region between the first filter 1411 and the second filter 1412, there is generated the condensed UFB-containing water WU1 that is condensed while containing the UFBs of 0.1 μm or greater and smaller than 1 μm and passes through the first filter 1411 but not the second filter 1412. The condensed UFB-containing water WU1 is transferred to the filling unit 500 once the UFB concentration measured by the UFB concentration sensor 1403 reaches a predetermined concentration or greater. In the filling unit 500, the container 1501 is filled with a certain amount of the UFB-containing liquid each time, and the UFB-containing liquid is transferred to the freezing unit 600. In the freezing unit 600, the condensed UFB-containing liquid WU1 is frozen and solidified by the slow freezing method to manufacture the solidified matter IC.

The UFB-containing liquid solidified matter IC manufactured as described above is a high quality solidified matter at a high concentration in which the disappearance and the change in function of the UFBs are suppressed, and the excellent features of the UFB-containing water can be reproduced even in a dissolved state. Particularly, in the present embodiment, since the condensed UFB-containing liquid WU1 that is condensed to have a high UFB concentration can be obtained between the first filter 1411 and the second filter 1412, the solidified matter IC obtained by freezing the condensed UFB-containing liquid WU1 can also obtains a high UFB concentration. Additionally, with the freezing and solidifying by the slow freezing method, the solidified matter IC becomes a solidified matter having a high visible light transmittance, and the high concentration solidified portion IC1 at a high UFB concentration and the low concentration solidified portion IC2 at a low UFB concentration are formed in the solidified matter IC. Accordingly, also in the present embodiment, as with the second and fifth embodiments, it is possible to obtain the highly concentrated solidified matter IC at a higher UFB concentration by taking out only the high concentration solidified portion IC1.

### SUMMARY

Combinations of various types of processing executed in the above-described first to sixth embodiments are described below. In Table 1, each item means the following details.
“Without circulation” means a case of not executing the circulation operation of putting back the UFB-containing liquid generated by the UFB generating unit 300 to the UFB generating unit. “With circulation” means a case of executing the circulation operation of putting back the UFB-containing liquid generated by the UFB generating unit to the UFB generating unit.
“Without condensation” means a case of not executing the processing of condensing the UFB-containing liquid, while “with condensation” means a case of executing the condensation processing.
“Without cutting-out” means a case of not cutting out the high concentration solidified portion IC1 from the solidified matter IC, while “with cutting-out” means a case of cutting out the high concentration solidified portion IC1 from the solidified matter IC.

Combinations that can be executed in an embodiment other than the first to sixth embodiments are indicated by o mark in the table.

TABLE 1

| | | with circulation | | |
|---|---|---|---|---|
| | | | with condensation | |
| | | | electric | physical |
| | without | without | method | method |
| | circulation | circulation | (electrophoresis) | (filtering) |
| without | first | third | fourth | sixth |
| cutting-out | embodiment | embodiment | embodiment | embodiment |
| with | second | ∘ | fifth | ∘ |
| cutting-out | embodiment | | embodiment | |

### OTHER EMBODIMENTS

In the above-described embodiments, there is described an example in which the high concentration solidified portion (first solidified portion) at a high UFB concentration is formed in a substantially central portion of the solidified matter (ice) of the UFB-containing liquid, while the low concentration solidified portion (second solidified portion) at a lower UFB concentration than that of the high concentration solidified portion is formed to cover the high concentration solidified portion. However, the positional relationship between the high concentration solidified portion and the low concentration solidified portion of the solidified matter manufactured by the slow freezing method is not necessarily limited to the case of cooling so as to obtain the above-described positional relationship.

Additionally, although an example of using pure water as the UFB-containing liquid is described in the present embodiments, the UFB-containing liquid for manufacturing a solidified matter is not limited to have a configuration of using pure water. The technique of the present disclosure is able to be applied for solidifying all the UFB-containing liquids that may be generated by the UFB generating unit.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-065431 filed Apr. 7, 2021, which is hereby incorporated by reference wherein in its entirety.

What is claimed is:

1. A manufacturing apparatus for a solidified matter of an ultra-fine bubble-containing liquid, comprising:
an ultra-fine bubble generating unit that generates an ultra-fine bubble-containing liquid by generating an ultra-fine bubble in a liquid; and
a cooling unit that generates a solidified matter of the ultra-fine bubble-containing liquid by cooling the ultra-fine bubble-containing liquid, wherein
the cooling unit cools the ultra-fine bubble-containing liquid such that a first solidified portion and a second solidified portion at a lower ultra-fine bubble concentration than that of the first solidified portion are formed in the solidified matter.

2. A manufacturing apparatus for a solidified matter of an ultra-fine bubble-containing liquid, comprising:
an ultra-fine bubble generating unit that generates an ultra-fine bubble-containing liquid by generating an ultra-fine bubble in a liquid; and
a cooling unit that generates a solidified matter of the ultra-fine bubble-containing liquid by cooling the ultra-fine bubble-containing liquid, wherein
the cooling unit cools the ultra-fine bubble-containing liquid such that a visible light transmittance of the solidified matter is 70% or more.

3. The manufacturing apparatus for the solidified matter of the ultra-fine bubble-containing liquid according to claim 1, wherein
the cooling unit solidifies the ultra-fine bubble-containing liquid by cooling the ultra-fine bubble-containing liquid for 12 hours or more per liter.

4. The manufacturing apparatus for the solidified matter of the ultra-fine bubble-containing liquid according to claim 1, wherein
the cooling unit solidifies the ultra-fine bubble-containing liquid by cooling the ultra-fine bubble-containing liquid for 24 hours or more per liter.

5. The manufacturing apparatus for the solidified matter of the ultra-fine bubble-containing liquid according to claim 1, further comprising:
a taking-out unit that takes out the first solidified portion from the solidified matter.

6. The manufacturing apparatus for the solidified matter of the ultra-fine bubble-containing liquid according to claim 5, wherein
the taking-out unit includes
a first laser output unit that irradiates the solidified matter with a first laser for detecting the ultra-fine bubble,
a recognizing unit that recognizes a portion in which the first laser emitted on the solidified matter scatters as a region in which the first solidified portion exists, and
a fabricating unit that performs fabrication to cut off a portion other than the first solidified portion, which is recognized by the recognizing unit, from the first solidified portion.

7. The manufacturing apparatus for the solidified matter of the ultra-fine bubble-containing liquid according to claim 6, wherein
the fabricating unit cuts off the portion other than the first solidified portion from the first solidified portion without contact with the solidified matter.

8. The manufacturing apparatus for the solidified matter of the ultra-fine bubble-containing liquid according to claim 7, wherein
the fabricating unit is a second laser output unit that irradiates the solidified matter with a carbon dioxide laser.

9. The manufacturing apparatus for the solidified matter of the ultra-fine bubble-containing liquid according to claim 1, further comprising:
a retaining unit that retains the ultra-fine bubble-containing liquid; and
a circulating unit that circulates the ultra-fine bubble-containing liquid between the retaining unit and the ultra-fine bubble generating unit, wherein
the retaining unit communicates with the cooling unit and supplies the cooling unit with the ultra-fine bubble-containing liquid retained inside the retaining unit.

10. The manufacturing apparatus for the solidified matter of the ultra-fine bubble-containing liquid according to claim 9, further comprising:
a gas dissolving unit that generates a gas dissolving liquid to be supplied to the ultra-fine bubble generating unit, wherein
the circulating unit performs a circulation operation in which the ultra-fine bubble-containing liquid retained in the retaining unit is put back to the retaining unit through the gas dissolving unit and the ultra-fine bubble generating unit.

11. The manufacturing apparatus for the solidified matter of the ultra-fine bubble-containing liquid according to claim 9, further comprising:
a condensing unit that condenses an ultra-fine bubble concentration of the ultra-fine bubble-containing liquid retained in the retaining unit, wherein
the cooling unit is supplied with the ultra-fine bubble-containing liquid condensed by the condensing unit.

12. The manufacturing apparatus for the solidified matter of the ultra-fine bubble-containing liquid according to claim 11, wherein
the condensing unit includes a flow inhibiting unit that inhibits a flow of an ultra-fine bubble contained in the ultra-fine bubble-containing liquid.

13. The manufacturing apparatus for the solidified matter of the ultra-fine bubble-containing liquid according to claim 12, wherein
the flow inhibiting unit includes an electrode that guides an ultra-fine bubble contained in the ultra-fine bubble-containing liquid retained in the retaining unit by electrophoresis.

14. The manufacturing apparatus for the solidified matter of the ultra-fine bubble-containing liquid according to claim 12, wherein
the flow inhibiting unit includes a first filter and a second filter arranged in the retaining unit,
the first filter is provided upstream of the second filter in a flow direction of the ultra-fine bubble-containing liquid in the retaining unit,
the first filter allows an ultra-fine bubble to pass therethrough while capturing an air bubble of 1.0 μm or greater, and
the second filter captures an ultra-fine bubble while allowing a liquid component to pass therethrough.

15. The manufacturing apparatus for the solidified matter of the ultra-fine bubble-containing liquid according to claim 1, wherein
the ultra-fine bubble generating unit generates an ultra-fine bubble by heating the ultra-fine bubble-containing liquid and generating film boiling.

16. A solidified matter of an ultra-fine bubble-containing liquid that is generated by cooling the ultra-fine bubble-containing liquid, characterized in that
the solidified matter includes a first solidified portion and a second solidified portion at a lower ultra-fine bubble concentration than that of the first solidified portion.
